(19) United States
(12) Patent Application Publication
(10) Pub. No.: US 2025/0141811 A1
(43) Pub. Date: May 1, 2025

(54) FLEXIBLE CONTROL FRAMES

(71) Applicant: QUALCOMM Incorporated, San Diego, CA (US)

(72) Inventors: Alfred ASTERJADHI, San Diego, CA (US); Abhishek Pramod PATIL, San Diego, CA (US); George CHERIAN, San Diego, CA (US); Abdel Karim AJAMI, San Diego, CA (US); Yanjun SUN, San Diego, CA (US); Sai Yiu Duncan HO, San Diego, CA (US); Gaurang NAIK, San Diego, CA (US)

(21) Appl. No.: 18/925,656

(22) Filed: Oct. 24, 2024

Related U.S. Application Data
(60) Provisional application No. 63/593,196, filed on Oct. 25, 2023.

(51) Int. Cl. H04L 47/36; H04W 28/06

(52) U.S. Cl. CPC H04L 47/365; H04W 28/06

(57) ABSTRACT

This disclosure provides methods, components, devices and systems for flexible control frames. Some aspects more specifically relate to indicating control information or control feedback in control frames including fields of flexible size. In some implementations, a wireless device may include control feedback in a dedicated feedback field within responsive control frames, within initial control frames, or both. The wireless device may indicate that a field includes the control feedback using bit sequences in one or more other subfields, such as a traffic identifier (TID) subfield or user information subfield. In some implementations, the control feedback information may provide another wireless device with additional information associated with a transmission, such as information associated with an upcoming data transmission or a reception status of a communicated data transmission.

### CROSS REFERENCE

The present application for patent claims the benefit of U.S. Provisional Patent Application No. 63/593,196 by ASTERJADHI et al., entitled “FLEXIBLE CONTROL FRAMES,” filed Oct. 25, 2023, assigned to the assignee hereof, and expressly incorporated by reference herein.

### TECHNICAL FIELD

This disclosure relates to wireless communication and, more specifically, to communicating control information and control feedback using flexible control frames.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, wireless devices may exchange control frames to facilitate data communications. For example, control frames may be exchanged to schedule one or more data frames, may indicate a reception status of one or more data frames, or a combination thereof.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless device. The first wireless device may include a processing system that includes processor circuitry and memory circuitry that stores code. The processing system may be operable to execute code to cause the first wireless device to receive, from a second wireless device, an initial frame requesting a response from the first wireless device and transmit a first control frame including first control information, the first control information including one or more sets of fields associated with one or more wireless devices, where: a first set of fields of the one or more sets of fields includes a first information field indicating an identifier associated with one or more second wireless devices comprising the second wireless device and a first feedback field including first control feedback; and the first information field includes a first bit sequence indicating that the first set of fields includes the first feedback field.

Another innovative aspect of the subject matter described in the disclosure can be implemented in a method for wireless communication performable by a first wireless device. The method may include receiving, from a second wireless device, an initial frame requesting a response from the first wireless device and transmitting a first control frame including first control information, the first control information including one or more sets of fields associated with one or more wireless devices, where: a first set of fields of the one or more sets of fields includes a first information field indicating an identifier associated with one or more second wireless devices comprising the second wireless device and a first feedback field including first control feedback; and the first information field includes a first bit sequence indicating that the first set of fields includes the first feedback field.

Another innovative aspect of the subject matter described in this disclosure can be implemented in an apparatus for wireless communication at a first wireless device. The apparatus may include means for receiving, from a second wireless device, an initial frame requesting a response from the first wireless device and means for transmitting a first control frame including first control information, the first control information including one or more sets of fields associated with one or more wireless devices, where: a first set of fields of the one or more sets of fields includes a first information field indicating an identifier associated with one or more second wireless devices comprising the second wireless device and a first feedback field including first control feedback; and the first information field includes a first bit sequence indicating that the first set of fields includes the first feedback field.

Another innovative aspect of the subject matter described in this disclosure can be implemented in a non-transitory computer-readable medium storing code for wireless communication at a first wireless device. The code may include instructions executable by one or more processors to receive, from a second wireless device, an initial frame requesting a response from the first wireless device and transmit a first control frame including first control information, the first control information including one or more sets of fields associated with one or more wireless devices, where: a first set of fields of the one or more sets of fields includes a first information field indicating an identifier associated with one or more second wireless devices comprising the second wireless device and a first feedback field including first control feedback; and the first information field includes a first bit sequence indicating that the first set of fields includes the first feedback field.

In some examples of the method, first wireless devices, and non-transitory computer-readable medium described herein, the identifier may indicate a plurality of the one or more second wireless devices.

In some examples of the method, first wireless devices, and non-transitory computer-readable medium described herein, the first control frame may include a trigger frame.

In some examples of the method, first wireless devices, and non-transitory computer-readable medium described herein, the first control feedback may indicate one or more operating parameters associated with peer-to-peer (P2P) communications between the second wireless device and a third wireless device.

In some examples of the method, first wireless devices, and non-transitory computer-readable medium described herein, the first control feedback may include a control feedback unit (CFU) that indicates an identifier associated with the first control feedback, an identifier of a link associated with the first control feedback, a length associated with the first control feedback, or any combination thereof.

In some examples of the method, first wireless devices, and non-transitory computer-readable medium described herein, the first control frame may include one or more feedback fields including at least the first control feedback, and where each of the one or more feedback fields includes respective control feedback for the one or more second wireless devices.

In some examples of the method, first wireless devices, and non-transitory computer-readable medium described herein, the first control frame may include one or more padding bits that follow the first set of fields, and where the one or more padding bits follow a frame check sequence included in the first control frame.

Some examples of the method, first wireless devices, and non-transitory computer-readable medium described herein may further include operations, features, means, or instructions for transmitting, to the second wireless device, a message requesting the second wireless device to initiate frame exchange with the first wireless device using a control frame that solicits the first control feedback, where the initial frame comprises an initial control frame and the first control frame comprises a initial control response based on transmission of the message.

In some examples of the method, first wireless devices, and non-transitory computer-readable medium described herein, the initial frame may include a request for the first wireless device to initiate frame exchanges with the second wireless device using a control frame that includes the first feedback field, and the first control frame may include an initial control frame based on receiving the initial frame including the request.

In some examples of the method, first wireless devices, and non-transitory computer-readable medium described herein, the first feedback field may indicate a request for the second wireless device to respond with a second control frame indicating whether the first control feedback was successfully received, and the request may be based on the first bit sequence and a first bit associated with a subfield of the first information field.

Some examples of the method, first wireless devices, and non-transitory computer-readable medium described herein may further include operations, features, means, or instructions for receiving the second control frame including second control information based on the first feedback field indicating the request, the second control information including a second set of fields, where: the second set of fields includes a second information field indicating the first wireless device and a second feedback field including second control feedback, the second control feedback indicating whether the first control feedback was successfully received; and the second information field includes a second bit sequence indicating that the second set of fields includes the second feedback field.

In some examples of the method, first wireless devices, and non-transitory computer-readable medium described herein, the second control frame may include a block acknowledgement (BA) control frame.

In some examples of the method, first wireless devices, and non-transitory computer-readable medium described herein, the first control frame may be a flexible control frame.

In some examples of the method, first wireless devices, and non-transitory computer-readable medium described herein, the first control feedback may indicate information associated with link adaptation, a buffer status report (BSR), a bandwidth query report (BQR), P2P communications, power management, coexistence, unavailability periods, a periodicity of the unavailability periods, an operating mode (OM), an uplink power headroom (UPH), one or more scheduling parameters, one or more interference patterns, a solicited physical protocol data unit type (PPDU), a solicited PPDU duration, a number of spatial streams (NSS), or any combination thereof.

In some examples of the method, first wireless devices, and non-transitory computer-readable medium described herein, the first bit sequence may indicate a first value and the first set of fields includes the first feedback field based on the first value being one or more reserved values associated with the first information field.

In some examples of the method, first wireless devices, and non-transitory computer-readable medium described herein, the first control information may include feedback information indicating whether the initial frame was successfully received.

In some examples of the method, first wireless devices, and non-transitory computer-readable medium described herein, the first control frame includes a BA control frame.

Another innovative aspect of the subject matter described in this disclosure can be implemented in a first wireless device. The first wireless device may include a processing system that includes processor circuitry and memory circuitry that stores code. The processing system may be configured to cause the first wireless device to transmit, to a second wireless device, a first control frame including a set of multiple user information fields and one or more feedback fields, where a first user information field of the set of multiple user information fields includes a bit sequence that indicates that the first control frame includes the one or more feedback fields, and where the one or more feedback fields include first control feedback indicating whether the second wireless device is to respond to the first control feedback with second control feedback and receive, from the second wireless device, a response frame responsive to the first control frame that is generated in accordance with the first control feedback.

Another innovative aspect of the subject matter described in the disclosure can be implemented in a method for wireless communication performable by a first wireless device. The method may include transmitting, to a second wireless device, a first control frame including a set of multiple user information fields and one or more feedback fields, where a first user information field of the set of multiple user information fields includes a bit sequence that indicates that the first control frame includes the one or more feedback fields, and where the one or more feedback fields include first control feedback indicating whether the second wireless device is to respond to the first control feedback with second control feedback and receiving, from the second wireless device, a response frame responsive to the first control frame that is generated in accordance with the first control feedback.

Another innovative aspect of the subject matter described in this disclosure can be implemented in an apparatus for wireless communication at a first wireless device. The apparatus may include means for transmitting, to a second wireless device, a first control frame including a set of multiple user information fields and one or more feedback fields, where a first user information field of the set of multiple user information fields includes a bit sequence that indicates that the first control frame includes the one or more feedback fields, and where the one or more feedback fields include first control feedback indicating whether the second wireless device is to respond to the first control feedback with second control feedback and means for receiving, from the second wireless device, a response frame responsive to the first control frame that is generated in accordance with the first control feedback.

Another innovative aspect of the subject matter described in this disclosure can be implemented in a non-transitory computer-readable medium storing code for wireless communication at a first wireless device. The code may include instructions executable by a processor to transmit, to a second wireless device, a first control frame including a set of multiple user information fields and one or more feedback fields, where a first user information field of the set of multiple user information fields includes a bit sequence that indicates that the first control frame includes the one or more feedback fields, and where the one or more feedback fields include first control feedback indicating whether the second wireless device is to respond to the first control feedback with second control feedback and receive, from the second wireless device, a response frame responsive to the first control frame that is generated in accordance with the first control feedback.

In some examples of the method, first wireless devices, and non-transitory computer-readable medium described herein, the first control frame, the response frame, or both may include one or more padding bits that follow a frame check sequence included in the first control frame, the response frame, or both.

In some examples of the method, first wireless devices, and non-transitory computer-readable medium described herein, the first control feedback may indicate a request for the second wireless device to respond with the second control feedback indicating whether the control feedback was successfully received and the response frame includes the second control feedback based on the request.

In some examples of the method, first wireless devices, and non-transitory computer-readable medium described herein, both of the first user information field and a second user information field may be associated with the second wireless device and the first user information field indicates one or more resources units for communicating a data frame and the second user information field indicates the first control feedback.

Some examples of the method, first wireless devices, and non-transitory computer-readable medium described herein may further include operations, features, means, or instructions for transmitting a data frame based on receiving the response frame, where the data frame may be generated in accordance with the first control feedback, the second control feedback, or both.

In some examples of the method, first wireless devices, and non-transitory computer-readable medium described herein, the first user information field may include a first subfield that indicates a length associated with the first user information field.

In some examples of the method, first wireless devices, and non-transitory computer-readable medium described herein, the first user information field may include one or more subfields and the first user information field and the one or more feedback fields may be subfields included within a same field of the first control frame based on a first subfield of the one or more subfields indicating the bit sequence.

In some examples of the method, first wireless devices, and non-transitory computer-readable medium described herein, a value indicated by the bit sequence may be a reserved value associated with the first user information field.

In some examples of the method, first wireless devices, and non-transitory computer-readable medium described herein, the first control feedback indicates information associated with link adaptation, a BSR, a BQR, P2P communications, power management, coexistence, an OM, a UPH, one or more scheduling parameters, or any combination thereof.

In some examples of the method, first wireless devices, and non-transitory computer-readable medium described herein, the first control frame may include a request-to-send (RTS) frame or a basic trigger frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example signaling diagram that supports communicating flexible control frames between a wireless access point (AP) and one or more wireless stations (STAs).

FIG. 3 shows an example of a flexible frame format usable for communications between a wireless AP and one or more wireless STAs.

FIG. 4 shows another example of a flexible frame format usable for communications between a wireless AP and one or more wireless STAs.

FIG. 5 shows an example process flow that supports communicating flexible control frames between a first wireless device and a second wireless device.

FIG. 6 shows an example process flow that supports communicating flexible control frames between a first wireless device and a second wireless device.

FIG. 7 shows a block diagram of an example wireless communication device that supports flexible control frames.

FIGS. 8 and 9 show flowcharts illustrating example processes performable by or at a first wireless device that supports flexible control frames.

FIG. 10 shows an example of trigger frame information usable for communications between a wireless AP and one or more wireless STAs.

FIG. 11 shows an example of a communication sequence supporting a trigger frame variant usable for communications between a wireless AP and one or more wireless STAs.

FIG. 12 shows another example of a communication sequence supporting a trigger frame variant usable for communications between a wireless AP and one or more wireless STAs.

FIG. 13 shows another example of a communication sequence supporting a trigger frame variant usable for communications between a wireless AP and one or more wireless STAs.

FIG. 14 shows an example of a trigger frame variant usable for communications between a wireless AP and one or more wireless STAs.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless devices (such as an access point (AP) or a station (STA)) communicating control information and control feedback. Some aspects more specifically relate to formatting flexible control frames (which may refer to control frames that carry variable amounts of data, such as additional control information or control feedback) to support communicating variable amounts of control information and control feedback. In some implementations, a wireless device may transmit quality of service (QOS) control information or high-throughput (HT) control information, which may be included in a header of a media access control (MAC) protocol data unit (MPDU). In some implementations, wireless devices may exchange feedback information related to the control information (which may be referred to as control feedback). However, such control fields may have a limited size (HT control may have a constant size of 4 bytes, QoS control may have a size of 2 octets), may only be present in certain frame types, may be restricted from being included in certain control frames, or the like. Thus, these control fields may lack flexibility for carrying variable amounts and types of control feedback information (such as link adaptation information, operating mode (OM) control information, among other examples), which may limit or otherwise fail to support target key performance indicators (KPIs) (such as low latency and high reliability).

Particular aspects of the subject matter described in this disclosure can be implemented to realize one or more of the following potential advantages. In some implementations, by including the control feedback in fields of variable size, the described techniques can be used to improve a reliability and effectiveness of communications (which may enable more dynamic adaptation of communication parameters). For example, a wireless device may include control feedback in a dedicated feedback field (which may be referred to as a control feedback field) within control response frames (such as a clear-to-send (CTS) frame or a block acknowledgment (BA) frame), within control frames that are not sent as a response to a soliciting frame (such as a trigger frame, a request-to-send (RTS) frame, a block acknowledgement request (BAR) frame, an unsolicited BA frame, etc.), or both. These control frames may be defined as initial control frames (ICF), which may refer to control frames that initiate a frame exchange sequence (such as a transmit opportunity (TXOP) or a service period), initial control response (ICR) frames, which may refer to control frames that are sent as an immediate response to an ICF, and control response frames (CRFs), which may refer to responsive control frames sent in response to any other frame that is not an ICF frame (such as a data frame). As an example, a first wireless device may transmit, to a second wireless device, a request to initiate a frame exchange using a control frame soliciting control feedback. In this example, the first wireless device may receive an initial frame that is an ICF and may respond with a first control frame that is an ICR. As another example, the first wireless device may receive an initial frame requesting for the first wireless device to initiate frame exchanges using a control frame that includes control feedback. In this example, the first wireless device may transmit a first control frame that is an ICF. It should be noted that the ICFs, the ICR frames, and the CRFs may be examples of any control frames exchanged between one or more wireless devices, and are not limited to the examples described herein.

In some implementations, these control frames may contain padding (e.g., one or more padding bits, a padding field), prior to or after a frame check sequence (FCS) (which may be included in one or more control frames, such as a first control frame and/or a response frame described herein), which may give the receiver additional time to process the additional control feedback. The padding field may be a variable field that contains bits of information that are part of the PPDU carrying the control frame but that do not contain useful information for the receiver (which may instead provide the receiver with extra time to process the information, prepare a responsive message, adapt one or more subsequent frame exchanges to account for updated parameters indicated by the control feedback, or any combination thereof). A transmitting wireless device may indicate that a field includes the control feedback using bit sequences in one or more other subfields of the control frame. In some implementations, the control feedback information may provide another wireless device with additional information associated with communications (such as one or more transmissions, one or more receptions, or a combination thereof), such as information associated with an upcoming data transmission (such as a modulation and coding scheme (MCS), bandwidth, quantity of spatial streams, transmit power, a target received signal strength indicator (RSSI), use of low density parity check (LDPC), or the like for subsequent PPDU communications), information associated with reception of a data transmission (such as indicating a percentage of a packet that was received successfully and a cause for portions that were not received successfully), among other examples. For example, some other examples of control feedback information may include coexistence parameters (such as unavailability periods, availability periods, a periodicity of unavailability periods, a periodicity of available periods), a buffer status report (BSR), an explicit request to obtain a portion of an ongoing TXOP to exchange frames with the TXOP holder or with a wireless STA (such as for peer-to-peer (P2P) communications), interference patterns, channel quality information, or any combination thereof. In some implementations, these values may be expressed as the maximum or minimum expected values, or the actual recommended values that should be used for subsequent frame exchanges (e.g., during that TXOP, or service period). In some implementations these values may express the parameters from the receiver side or from the transmitter side, or both.

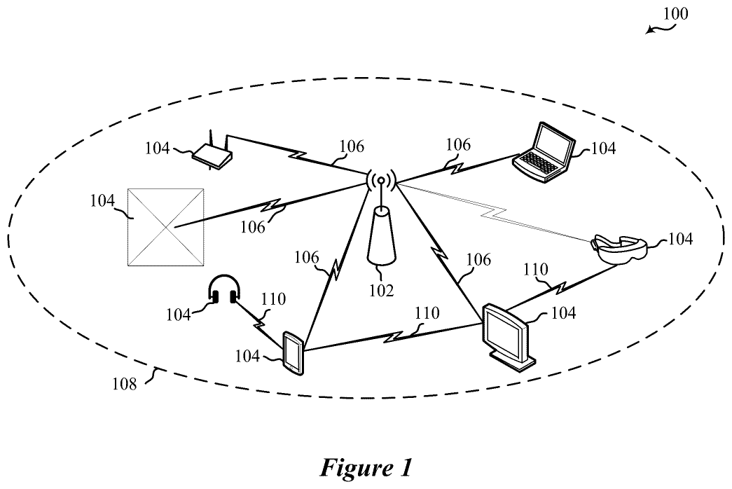

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater RSSI or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHz, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

In some implementations, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some implementations in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some implementations, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

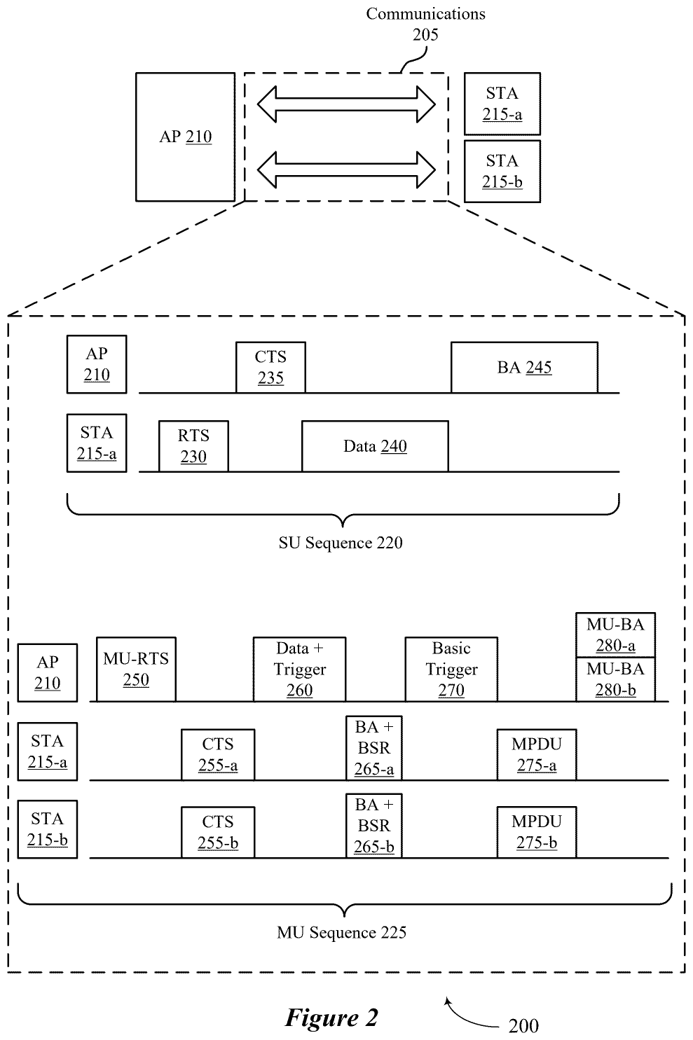

FIG. 2 shows an example signaling diagram 200 that supports communicating flexible control frames between a first wireless device, such as a wireless access point (AP), and one or more second wireless devices, such as one or more wireless stations (STAs). The signaling diagram 200 may implement or be implemented to realize one or more aspects of the wireless communications system 100. For example, the signaling diagram 200 illustrates communications 205 between an AP 210 and one or more STAs 215, such as a STA 215-a and a STA 215-b, which may be examples of corresponding devices illustrated by and described with reference to FIG. 1. In some implementations, the communications 205 may be an example of one or more types of communications sequences between the AP 210 and the STAs 215, such as a single-user (SU) sequence 220 or a multi-user (MU) sequence 225. It should be noted that while the illustrated example refers to an AP 210 communicating with one or more STAs 215, the sequence may support other device configurations, such as a STA 215 indicating control feedback to one or more APs 210, a STA 215 indicating control feedback to one or more other STAs 215, a first wireless device communicating with a second wireless device, or any combination of devices with different functionalities.

In some implementations, a first wireless device, such as the AP 210, may communicate with a second wireless device, such as a single STA, such as the STA 215-a, in an SU sequence 220. In some implementations, one of the AP 210 or the STA 215-a may initiate communications using an ICF. The ICF may be a variant of a trigger frame, an RTS frame, a BAR frame, or the like (which may be frames used to initiate a transmission opportunity (TXOP) for communicating data). As described herein, the ICF may be an example of a first control frame, such as when the AP 210 receives a request to initiate frame exchanges with the STA 215-a using a control frame that includes first control feedback. In some implementations, wireless devices may transmit an ICR frame, which may be an example of a CTS frame, a block acknowledgment (BA) frame, an MPDU sent in response to an initiating control frame (such as in a trigger based PPDU format), or the like. As described herein, the ICR frame may be an example of a first control frame, such as when the AP 210 transmits a request for the STA 215-a to initiate frame exchanges using a control frame that solicits first control feedback and receives an ICF from the STA 215-a. Alternatively, the ICR frame may be an example of a second control frame, such as a control frame communicated by a wireless device in response to an ICF. In some implementations, a wireless device may transmit a CRF (which may be an example of a second control frame), such as a BA frame 245 (which may be a CRF sent in response to a soliciting frame that is not a control frame) to another wireless device indicating feedback for data. In some examples, an ICR may be a request to send frame 230, a trigger frame (and any variants of the trigger frame), a BAR frame, or the like, In some examples, a control response frame to the initiating control frame (e.g., request to send frame 235) may include, for example, a clear to send frame, a BA frame 245, a MPDU that is sent in response to the initiating control frame in trigger based PPDU format, or the like. In some examples, the control response frame may include a soliciting frame that is not a control frame (such as a BA frame 245).

In the example SU sequence 220, the ICF may be an example of an RTS frame 230. For example, the STA 215-a may transmit an RTS frame 230 to initiate and protect or maintain (such as by reserving a wireless channel for some duration) an upcoming TXOP for the STA 215-a. In the example SU sequence 220, the ICR may be an example of a CTS frame. For example, the AP 210 may transmit a CTS frame 235, which may indicate that the wireless channel is available for the STA 215-a to transmit data. In some implementations, the STA 215-a may transmit data 240 to the AP 210 during the TXOP (such as the TXOP scheduled by the RTS frame 230 and the CTS frame 235 exchange). In the example SU sequence 220, the CRF may be an example of a BA frame. For example, the AP 210 may transmit a BA frame 245 in response to the data 240. In some implementations, the BA frame 245 may include one or more block acknowledgment bitmaps (such as one for each STA 215 or TID tuple) to indicate whether one or more data packets associated with the data 240 (such as PPDUs, MPDUs, MAC service data units (MSDUs), or the like) were successfully received at the AP 210. Such BA frames 245 may support the communicating devices resetting a BA scoreboard and advancing BA windows.

As another example, the AP 210 may communicate with multiple STAs, such as both of the STA 215-a and the STA 215-b, in an MU sequence 225. In some implementations, the AP 210 may transmit an MU-RTS trigger frame 250 (which may be referred to as an ICF, a first control frame, or both) addressed to the STA 215-a and the STA 215-b to initiate a TXOP (such as an in an enhanced multilink single-radio (eMLSR) sequence) for the AP 210 to transmit data to the STA 215-a and the STA 215-b. In some implementations, the STA 215-a and the STA 215-b may respectively transmit a ICR frame, such as a CTS frame 255-a and a CTS frame 255-b (which may be examples of the CTS frame 225) to the AP 210 in response to the MU-RTS frame 250. Based on receiving the CTS frame 255-a and the CTS frame 255-b (which may be received at the AP 210 as a single CTS frame 255, such as when the content of the CTS frame 255-a and the CTS frame 255-b are the same), the AP 210 may send data frames 260 to either STA 215-a, to the STA 215-b, or both. The data frames 260 may be carried in an MU PPDU format, such that each STA 215 receives a respective data frame within the MU PPDU (such as if the CTS frames 255 indicate the wireless channel is available). In some implementations, the data frame 260 (which may be an example of an MU PPDU containing one or more PSDUs addressed to one or more STAs 215, where each PSDU may include one or more MPDUs addressed to the one or more STAs 215 as part of an A-MPDU format) may include one or more trigger frames, which may indicate that the STA 215-a and the STA 215-b are to transmit a response (such as a CRF) to the PPDU containing the data frames 260. The response (which may be an example of a TB PPDU, EHT PPDU, or UHR TB PPDU) may be expected to contain additional information, which may depend on a type of the trigger frame or may depend on the information the responding STA includes in the response. For example, the trigger may be a BSR poll trigger frame, which may request that the STA 215-a and the STA 215-b respond with respective BSRs along with the acknowledgment feedback (such as BA feedback) of the received data frames. In some implementations, the STA 215-a and the STA 215-b may respond to the data frame 260 with a BA frame 265-a and a BA frame 265-b, respectively, to indicate feedback associated with the data frame 260. Additionally, or alternatively, the STA 215-a and the STA 215-b may include a respective BSR in the BA frame 265-a and the BA frame 265-b (such as when a trigger soliciting the BSR is included in the data frame 260). Additionally, or alternatively, the STAs 215 may include additional control feedback in the BA frames 265, such as link adaptation parameters, coexistence parameters, and scheduling information, among other examples. In some examples, coexistence parameters may include unavailability periods, availability periods, periodicity of availability periods, periodicity of unavailability periods, link adaptation feedback (e.g., recommended/requested MCS, NSS, TX Power, BW, PPDU format, target RSSI, etc.) to be used for subsequent PPDU transmissions (RX and TX), buffer status reports, explicit requests to obtain a portion of the ongoing TXOP to exchange frames with the TXOP holder or with other STAs (e.g., P2P), interference patterns, channel quality information, etc.

In some implementations of the MU sequence 225, the AP 210 may solicit one or more data transmissions (such as TB PPDU transmissions) from the STA 215-a and the STA 215-b using, for example, a basic trigger frame 270 (which may be an example of a first control frame). In response to the basic trigger frame 270, the STA 215-a and the STA 215-b may transmit one or more MPDU frames 275-a and one or more MPDU frames 275-b, respectively, including data solicited by the basic trigger frame 270. In some implementations, the AP 210 may respond to the one or more MPDU frames 275-a and the one or more MPDU frames 275-b by transmitting one or more BA frames. For example, the AP 210 may transmit a multi-STA BA frame 280-a to STA 215-a and a multi-STA BA 280-b to the STA 215-b (which may be individually addressed to each STA 215 and multiplexed in frequency, such as in an MU OFDMA PPDU), which may indicate feedback associated with the data frame 275-a and the data frame 275-b, respectively. Alternatively, the AP 210 may transmit a single multi-STA BA frame 280 that is broadcast and addressed to both the STA 215-a and the STA 215-b (such as in a non-HT PPDU format).

In some implementations, a communicating device (such as the AP 210 or a STA 215) may communicate control information or feedback information using control frames to support exchanging frames. For example, such control frames may be examples of ICFs (such as the RTS frame 230 or a variant of the RTS frame 230, the MU-RTS trigger frames 250 or variants of the MU-RTS trigger frames 250, a BAR frame or variants of the BAR frame, or the like), ICR frames or CRFs to the initiating control frames (such as the CTS frame 235 or variants of the CTS frame 235, a variant of a trigger frame that is sent in response to a soliciting trigger frame (such as a frame requesting a response from the receiver), a BA frame or variants of a BA frame, trigger-based PPDUs that contain one or more MPDUs or variants of the trigger-based PPDUs, or the like), or both. These frames may include (such as in a service field or MAC header) bandwidth information associated with an upcoming data transmission or frame exchange. As another example, such control frames may be examples of control frames send in response to one or more soliciting frames (such as the BA frame 245, the BA and QoS null or data frames that carry control information in their MAC header (such as in a BSR), the multi-STA BA frames, or the like), which may not be initiating control frames, and may indicate a receive status of data using one or more BA bitmaps. In some implementations, such control frames may be referred to as flexible control frames (which may be control frames that carry variable amounts of control information or control feedback information in addition to existing information).

In some implementations, such frames may include control information in a feedback field. For example, a BA frame may include a BA control field, and may further include a BA information field, a feedback field, or a combination thereof. In some implementations the feedback field may be located within the BA information field or after the BA information field. In some implementations the feedback field may further include zero or more QoS Control fields, zero or more HT control fields (or variants of the HT control fields), and newly defined control “feedback” fields for UHR. In some implementations, a variant of the HT Control field (such as an aggregated control (A-Control) field) may only be present in the MAC header of certain types of frames (such as frames that are not control frames) and may be limited in size to 4 octets. The A-Control field may indicate various types of control information, such as triggered response scheduling (TRS) information, operating mode (OM) information, high-efficiency (HE) link adaptation (HLA) information, BSR information, uplink power headroom (UPH) information, a bandwidth query report (BQR), command and status (CAS) information, extremely high throughput (EHT) OM information, single response scheduling (SRS) information, an AP assistance request (AAR), or any combination thereof, among other examples. However, the A-Control field in these non-control frames may be relatively inflexible for communicating larger amounts of information (such as further control information or control feedback). For example, size limitations may allow for only two types of control information to be communicated in a control field (such as OM control and UPH control occupying 28 bits of information or BQR control and CAS control occupying 26 bits of information).

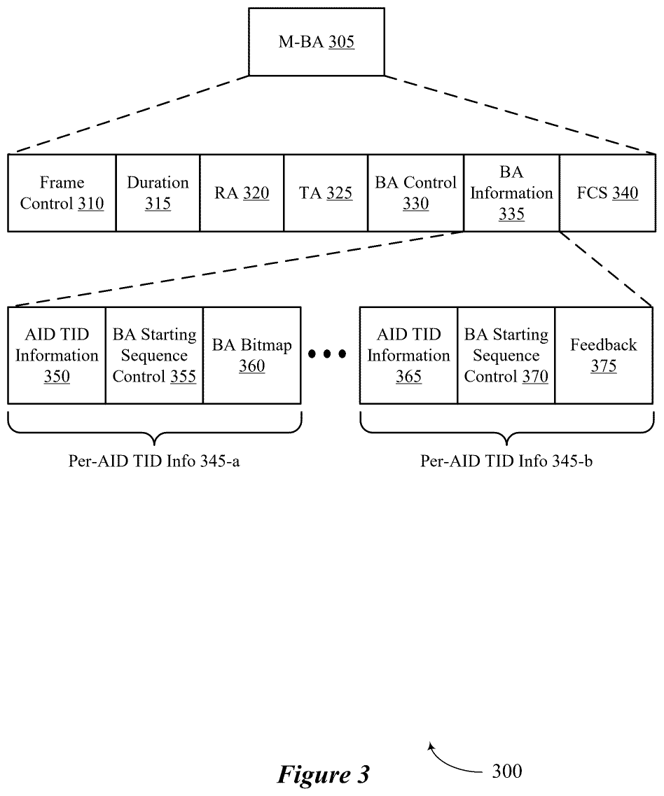

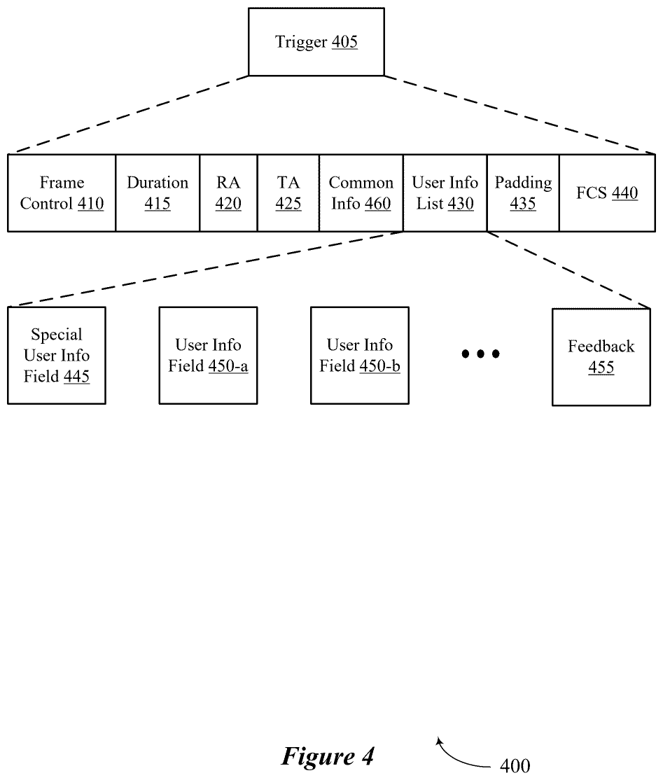

To support communicating additional control information or control feedback, the communicating devices may piggyback the additional information on one or more frames used as part of the SU sequence 220 and the MU sequence 225 (which may be referred to as flexible control frames). For example, the additional information may be included in a feedback field of responsive frame, such as a multi-STA BA frame (as described further with reference to FIG. 3), may be included in a feedback field of an ICF, such as a variant of a trigger frame (as described further with reference to FIG. 4), an RTS or CTS (to self) frame, or a combination thereof, among other examples. In some implementations, the devices may use the additional control information or control feedback to improve communications. For example, such techniques may facilitate the AP 210 suggesting bandwidth for performing future communications and a STA 215 responding with an acceptance or an alternative suggested bandwidth to inform a decision of the AP 210. As another example, using the BA frame 245, the AP 210 may be capable of indicating a percentage of the data 240 that was successfully received, but may be incapable of indicating a cause for failing to receive some portions in the control fields (such as due to link degradation or a congested channel).

In some implementations, the feedback field may be added as part of the BA information field. In an example, the feedback field may be included in one or more Per-AID TID Info fields that are identified by a combination of the ACK Type field and the TID field. In some implementations, one or more feedback fields may be included in a Multi-STA BA frame, for example feedback fields addressed to each respective intended recipient. In some implementations, the length of the feedback field may be indicated in a fragment number field of the BA starting sequence control field of each Per-AID TID Info field.

In some implementations, the control feedback may be appended to the BA information field and the presence of the feedback field may be advertised via the BA Control field of the BA frame (which may be applicable to both compressed BA, and Multi-STA BA). In some implementations, the length of the feedback field may be indicated at a start of the feedback field, may be derived from the length of the control frame (such as a BA frame), or may be obtained from an L-SIG field (or a length in the A-MPDU delimiter) minus the length of the BA frame without the feedback field.

In some implementations, the feedback field may be formatted to include one or more control feedback units (CFUs). A CFU may include a control ID subfield to identify a type of control information associated with the CFU, a link ID subfield to identify a link for which the CFU applies to (such as via a link ID bitmap indicating a list of links applicable to the CFU), a length subfield to indicate a length of the CFU, and a control information subfield indicating the control information or feedback. In some implementations, the feedback field may include a length subfield indicate a total length of the feedback field.

As an example of communicating control feedback in existing frames, the AP 210 may transmit an initial MU-BAR frame to the STA 215-a, the MU-BAR frame including control feedback (e.g., including a feedback field) indicating an ELA request. The STA 215-a may respond to the AP 210 with an M-BA frame that acknowledges one or more received MPDUs and indicates control feedback, which may include an ELA response (such as an ELA report for fast link adaptation), a BSR (such as for subsequent uplink data), OM information, interference patterns, channel quality information, or any combination thereof, among other examples. Other examples of control feedback information may include a specified bandwidth (such as a maximum bandwidth), a number of spatial streams (NSS) (such as a maximum NSS), a specified MCS (such as a maximum MCS), a low-density parity check (LDPC) to use for a TXOP or service period, a PPDU format, a target RSSI or any combination thereof. In some implementations, the control feedback may include (in addition to previous examples or alone)

After receiving the M-BA frame, the AP 210 may continue with the frame exchange while accounting for the received feedback (such as the ELA report or the BSR). For example, the AP 210 may transmit a data frame to the STA 215-a that is adapted according to the received control feedback. In some implementations, the data frame may additionally act as an implicit acknowledgment to the STA 215-a that the AP 210 received the M-BA frame (such as when the STA 215-a solicits or requests a response to the M-BA frame). In some implementations, the STA 215-a may respond to the data frame with an M-BA frame indicating feedback for MPDUs of the data frame, and may report to the AP 210, in the M-BA frame, that traffic for peer-to-peer (P2P) communications is ready at the STA 215-a. Further, the M-BA frame may include one or more operating parameters the STA 215-a plans to use for a remainder of a TXOP (e.g., one or more operating parameters associated with P2P communications between the STA 215-a and another STA 215). For example, a first wireless device (such as the AP 210) may indicate P2P operating parameters between a second wireless device (such as the STA 215-a) and a third wireless device (such as another STA 215). Based on receiving the M-BA frame, the AP 210 may determine to allocate a remainder of the TXOP to the STA 215-a for the P2P communications, which may include sending an MU-RTS trigger frame (such as a first control frame) to the STA 215-a to initiate the TXOP. Thus, by including the additional information in existing frame exchanges, the devices may experience improved reliability and reduced latency when communicating in the SU sequence 220 and the MU sequence 225.

FIG. 3 shows an example flexible frame format 300 usable for communications between a first wireless device, such as a wireless AP, and one or more second wireless devices, such as one or more wireless STAs. The flexible frame format 300 may illustrate a responsive frame, such as an M-BA frame 305 (which may be referred to as a CRF, which may be an example of a first control frame or a second control frame described herein), which may be an example of a corresponding frame described with reference to FIG. 2. In some implementations, the M-BA frame 305 may indicate feedback information (such as a receive status) for one or more initial frame exchanges (such as one or more data frames that solicit an immediate response, or one or more BAR frames, or a RTS response), where the M-BA frame 305 may be addressed to one or more receiving wireless devices (such as those that sent the soliciting frames). In some implementations, the M-BA frame 305 may contain only acknowledgment feedback information (such as receive status) for one or more data frames received from a STA, or only control feedback for a STA, or both of the acknowledgment feedback information and the control feedback. Such frames containing variable amounts of data or information to support communicating control feedback in addition to other information (such as acknowledgement feedback) may be referred to as flexible control frames. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

For example, a first wireless device, such as an AP (e.g., the AP 210 described with reference to FIG. 2), may transmit the M-BA frame 305 to multiple second wireless devices, such as multiple STAs (e.g., the STAs 215 described with reference to FIG. 2), indicating respective acknowledgment feedback information for each STA (the M-BA frame 305 may be an example of a first control frame transmitted in response to an initial frame). Further, the M-BA frame 305 may additionally include control feedback for one or more of these STAs. The M-BA frame 305 may be sent in response to PPDUs received from multiple STAs (such as a response to TB PPDUs in a broadcast manner), may be sent in response to PPDUs received from a single STA (such as a response to non-TB PPDUs in a unicast manner), may be sent in response to PPDUs that solicit control feedback (such as a trigger frame), or any combination thereof. Additionally, or alternatively, the M-BA frame 305 may be sent to provide unsolicited control feedback, such as an unsolicited BSR, an unsolicited bandwidth query report (BQR), or an ELA report, among other examples. In some implementations, the M-BA frame 305 may be sent in response to another M-BA frame that includes control feedback, where the M-BA frame 305 may indicate acknowledgment of the received control feedback (such as acknowledging the requested response of a soliciting M-BA frame).

The M-BA frame 305 may include one or more fields carrying information. For example, the M-BA frame 305 may include a frame control field 310, a duration field 315, a receiver address (RA) field 320, a transmitter address (TA) field 325, a BA control field 330, a BA information field 335, and a frame check sequence (FCS) field 340. In some implementations, such fields may include one or more subfields (which may be referred to as sets of fields). For example, the BA information field 335 may include one or more sets of subfields (such as one or more sets of fields) corresponding to respective receiving STAs. Each set of subfields may be referred to as per-association identifier (AID) traffic identifier (TID) information 345, and may indicate a respective STA as well as acknowledgment feedback for the respective STA.

As an example, the BA information field 335 may include first per-AID TID information 345-a associated with a first STA. In some implementations, the first per-AID TID information 345-a may include an AID TID information subfield 350 (which may be referred to as a first information field), a BA starting sequence control subfield 355, and a BA bitmap subfield 360. In some implementations, the AID TID information subfield 350 may indicate an AID and TID associated with the first STA (such as in subfields of the AID TID information subfield 350), and the BA starting sequence control subfield 350 and the BA bitmap subfield 360 may support the first STA receiving and identifying acknowledgment feedback for a data transmission. For example, the BA bitmap subfield 360 may indicate which MPDUs of a data transmission were received successfully for an associated TID and the BA starting sequence control subfield 370 may indicate a length of the BA bitmap subfield 360 (such as in octets). Additionally, or alternatively, another Per-AID TID information field 345 that is addressed to the first STA may contain control feedback for the STA, for example while not including acknowledgment feedback (such as the BA bitmap). In some implementations, a STA may use information in the AID TID information field 350 to determine the presence and length of the feedback field (which may be a field including control feedback), which may support the STA identifying whether a feedback field 375 is present in a per-AID TID information 345.

Additionally, or alternatively, the BA information field 335 may include second per-AID TID information 345-b associated with a second STA. In some implementations, the second per-AID TID information 345-b may include an AID TID information subfield 365, a BA starting sequence control subfield 370, and a feedback field 375. The AID TID information subfield 365 may indicate an AID and TID associated with the second STA, which may support the second STA identifying that the second per-AID TID information 345-b includes the control feedback 375. In some implementations, the first per-AID TID information 345-a and the second per-AID TID information 345-b may be addressed to the same STA. In some implementations, the feedback field 375 (which may be a first feedback field) may be addressed to multiple STAs (such as all of or a subset of the STAs receiving the M-BA frame 305). In such examples, the AID field in the AID TID Information may be set to a pre-defined value that identifies a group of STAs (such as a set of multiple STAs) for broadcast communications (such as AID 0, etc.). That is, a control frame may include an identifier associated with one or more second wireless devices (such as a set of second STAs), and may indicate multiple of the one or more second wireless devices. For example, Table 1 below shows various interpretations of a respective per-AID TID information 345 that may be made by a receiving STA.

TABLE 1

| | | Presence of BA | |
|---|---|---|---|
| ACK Type | TID | Starting Sequence | |
| Subfield | Subfield | Control and BA | Context of Per-AID TID Information in Multi- |
| Value | Value | Bitmap Subfields | STA BA Frame |
| 0 | 0-7 | Present | BA context: sent as BA to QoS data frame that |
| | | | solicits a BA frame response or to a BAR frame |
| 1 | 0-7 | Not Present | ACK context: sent as an ack to QoS data or QoS |
| | | | null frame that solicits an ack frame response |
| 0 or 1 | 8-13 | N/A | Reserved |
| 0 | 12 | Present | Control feedback context: sent in response to a |
| | | | PSDU and contains control feedback for an |
| | | | addressed STA |
| 0 | 13 | Present | Control feedback context: sent in response to a |
| | | | PSDU and contains control feedback for the |
| | | | addressed STA and solicits an immediate |
| | | | acknowledgment |
| 1 | 13 | Not Present | Control feedback context: sent as an ack to a |
| | | | control frame that contains control feedback |
| 1 | 14 | Not Present | All ACK context: sent as an ACK to an A- |
| | | | MPDU or multi-TID A-MPDU that contains an |
| | | | MPDU that solicits an immediate response and |
| | | | all MPDUs contained in the A-MPDU or multi- |
| | | | TID A-MPDU are received successfully |
| 0 | 15 | N/A | Reserved |
| 1 | 15 | Not Present | Management frame/PS-Poll ACK context: sent |
| | | | as an acknowledgment to a management frame |
| | | | carried in an A-MPDU or S-MPDU, or a PS-Poll |
| | | | frame in an S-MPDU |

As shown in Table 1, a receiving STA that is the intended recipient (which may be specified by the RA field of the frame or the value of the AID11 field of the Per-AID TID Info field) may interpret an associated per-AID TID information 345 according to an ack type subfield value (such as a bit in a corresponding AID TID information subfield), a TID subfield value (such as a bit sequence in a corresponding AID TID information subfield), and whether the BA starting sequence control and BA bitmap subfields are present in the associated per-AID TID information 345. For example, the AID TID information 365 in the second per-AID TID information 345-b may include a TID subfield value that is reserved (such as the reserved values of 8-13 shown in Table 1) to indicate that the second per-AID TID information 345-b includes the feedback field 375. In some implementations, the feedback field 375 in the second per-AID TID information 345-b may include more data (such as a greater quantity of octets or bytes) than the BA bitmap subfield 360 in the first AID TID information 345-a in order to carry control feedback, BA feedback, or both. For example, the BA bitmap subfield 360 may indicate 0, 4, 8, 16, or 32 octets, while the feedback field 375 may indicate 0, 4, 8, 16, 32, 64, or 128 octets.

In some implementations, the feedback field 375 may include control feedback without soliciting a response acknowledging the control feedback (such as for an ACK Type subfield value of 0 and a TID subfield value of 12). In some other examples, the feedback field 375 may include control feedback with a request soliciting a response acknowledging the control feedback (such as for an ACK Type subfield value of 0 and a TID subfield value of 13). Additionally, or alternatively, the feedback field 375 may include an acknowledgment of received control feedback (such as for an ACK Type subfield value of 1 and a TID subfield value of 13). Other combinations of ACK Type and reserved TID values may support various control feedback communication mechanisms.

It should be noted that the BA information field 335 may include per-AID TID information 345 for any quantity of receiving STAs, and a per-AID TID information 345 including a feedback field 375 may be placed anywhere within the BA information field 335. For example, a per-AID TID information 345 including a feedback field 375 may be located near the beginning of the BA information field 335 to provide additional processing time for a receiving STA or may be located near the end of the BA information field 335 to provide additional generation time for a transmitting STA. Additionally, or alternatively, the feedback field 375 may be appended to the M-BA frame 305 after the BA information field 335. For example, the BA control field 330 may include a subfield indicating a BA type, which may indicate the presence of the feedback field 375 after the BA information field 335 using one or more reserved values.

FIG. 4 shows an example flexible frame format 400 usable for communications between a first wireless device, such as a wireless AP, and one or more second wireless devices, such as one or more wireless STAs. The flexible frame format 400 may illustrate a trigger frame 405 (which may be referred to as an ICF, a first control frame, or both) that is used by a communicating device (such as an AP or STA) to initiate, protect, or maintain a TXOP. For example, the trigger frame 405 may be an example of an ICF, such as a request to send frame, a clear to send frame (such as the CTS frame 235), an MU-RTS frame 250, a clear to self frame 255, or a basic trigger frame 270 described with reference to FIG. 2. In some implementations, the trigger frame 405 (which may be referred to as a first control frame) may include a feedback field to communicate additional control information or feedback to a receiving device. Such frames containing variable amounts of data or information to support communicating control feedback in addition to other information (such as information related to a TXOP) may be referred to as flexible control frames. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

The trigger frame 405 (for example a first control frame) may be sent as a single MPDU, such as an initial frame of a TXOP or during the TXOP. In some implementations, the trigger frame 405 may solicit a response with control feedback, which may be indicated by a bit in the trigger frame 405 or a reserved value of a TXOP sharing mode. For example, a bit value of ‘1’ in the trigger frame 405 (such as an MU-RTS) may indicate that the trigger frame 405 is soliciting a responsive frame (such as an M-BA frame or a CTS frame with control feedback or a trigger frame variant with control feedback). Alternatively, the trigger frame 405 may be sent as part of an A-MPDU, such as part of an MU exchange (such as a basic trigger frame). In some examples, the trigger frame 405 may contain only control feedback in which no response (such as a CTS, a trigger-based PPDU, or the like) is requested. In some implementations, the trigger frame 405 may be an example of a null data packet (NDP) feedback report poll (NFRP) trigger, which may solicit an NDP TB PPDU acknowledgment from one or more receiving STAs. In some examples, control feedback in a trigger frame may act as an initial control frame in SU sequence exchanges, MU sequence exchanges, or both, as discussed herein, and may cover both cases of soliciting a control response and not soliciting a control response.

The trigger frame 405 may include one or more fields carrying information. For example, the trigger frame 405 may include a frame control field 410, a duration field 415, an RA filed 420, a TA field 425, a common information field 460, a user information list 435, a padding field 435, and an FCS field 440. In some implementations, these fields may include one or more subfields. For example, the user information list 430 may include a special user information field 445, one or more user information fields 450 (such as a user information field 450-a and a user information field 450-b), a feedback field 455, or any combination thereof. In some implementations, the feedback field 455 may occupy a user information field 450 and a receiving device may identify the field as the feedback field 455 based on an AID subfield value of the field. For example, a receiving device may identify a user information field 450 with an AID subfield value (such as an AID12 value) that is reserved (such as a value of 2024), which may indicate that the user information field 450 is used as a feedback field 455. In some implementations, the feedback field 455 may be located after the common information field 460 or after the special user information field 445 (located near the beginning of the user information list 430) to give additional time for a receiving STA to process the control feedback.

In some implementations, the feedback field 455 may indicate control feedback for one or more receiving devices. For example, in a broadcast scenario, a feedback field 455 located at the end of the user information list 430 may indicate control feedback for each receiving STA (such as STAs indicated by the rest of the user information list 430). As another example, if the RA 420 indicates a specific STA, the feedback field 455 may include control feedback for the indicated STA. Alternatively, the user information list 430 may include multiple feedback fields 455 including control feedback for respective STAs (for example, each of one or more feedback fields may include respective control feedback for one or more receiving STAs). For example, multiple user information fields 450 may indicate the same STA (such as by using an AID value), which may indicate that additional user information fields 450 contain control feedback for the addressed STA.

As an example, if the user information field 450-a and the user information field 450-b include an AID value indicating the same STA, the STA may identify information associated with data (such as resource units (RUs) for a TB PPDU) included in the user information field 450-a and may identify the other user information field 450-b as a feedback field 455. It should be noted that any quantity of user information fields 450 may be contain control feedback for the same STA and any quantity of STAs may be indicated in the user information list 430. In some other examples, a transmitting device may configure the trigger frame 405 and user information fields 450 to support a variable length (such as a quantity of bytes or octets) such that a user information field 450 may indicate an associated length within the user information field 450 (such as after the AID12 subfield). In such examples, a STA may identify that a user information field 450 includes control feedback according to the indicated length. In some implementations, the first user information field addressed to the STA may be identified as containing information associated with data transmissions (such as resource units and other transmission parameters) in response to the trigger frame 405, and other user information fields addressed to the same STA may be identified as containing control feedback. In some implementations, a bit in the user information field may support the STA differentiating between the two functionalities.

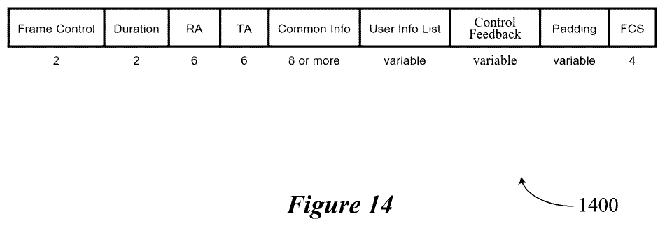

Additionally, or alternatively, the trigger frame 405 may include the feedback field 455 in the padding field 435 (such as after the user information list 430 described further with reference to FIG. 14). In some implementations, indicating control feedback in the padding field 455 may support the receiving STA preparing responsive control feedback when generating a responsive frame.

In some implementations, the feedback field 455 may report control feedback to one or more receiving STAs as well as soliciting a response from the one or more receiving STAs. For example, the trigger frame 405 may solicit a BA and BSR frame from a receiving STA (such as when the trigger frame 405 is sent alongside a data frame), and the control feedback may indicate transmission parameters for the one or more STAs (such as a bandwidth limitation) and may request that the responsive BA and BSR frame include feedback in terms of the control feedback (such as link adaptation). Additionally, or alternatively, the control feedback may indicate parameters associated with an upcoming data transmission. For example, an AP may transmit the trigger frame 405 with the control feedback indicating the AP intends to initiate an uplink MU sequence, and may include respective control feedback for each receiving STA indicating parameters for transmitting data in the uplink MU sequence (such as respective RUs and a sequence type). Alternatively, the feedback field 455 may include the control feedback without soliciting a response from receiving STAs.

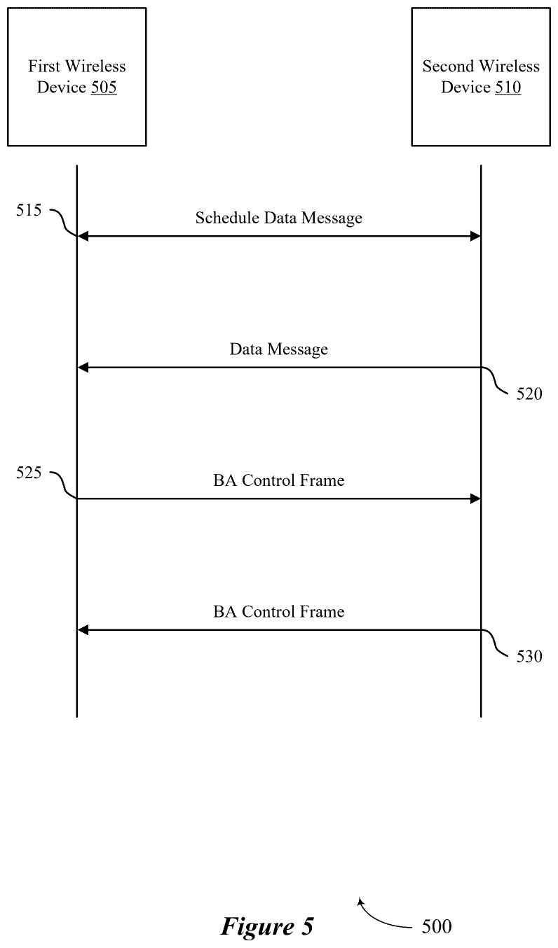

FIG. 5 shows an example process flow 500 that supports communicating flexible control frames between a first wireless device (such as an AP) and a second wireless device (such as a STA). The process flow 500 may implement, or be implemented by, one or more aspects of the wireless communications system 100, the signaling diagram 200, and the flexible frame format 300. For example, the process flow 500 illustrates communications between a first wireless device 505 and a second wireless device 510, which may be examples of APs or STAs described with reference to FIGS. 1-3. The process flow 500 may support an SU sequence or an MU sequence, and may be performed between any quantity of wireless devices. In the following description of the process flow 500, the operations may be performed (such as reported or provided) in a different order than the order shown, or the operations performed by the example devices may be performed in different orders or at different times. For example, specific operations also may be left out of the process flow 500, or other operations may be added to the process flow 500. Further, although some operations or signaling may be shown to occur at different times for discussion purposes, these operations may actually occur at the same time. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

At 515, the first wireless device 505 and the second wireless device 510 may schedule an initial frame. The initial frame may be a data message. In some implementations, scheduling the initial frame may include communicating a control frame (such as an ICF). For example, the first wireless device 505 and the second wireless device 510 may communicate one or more ICFs and ICR frames (such as an RTS and CTS frame exchange) to initiate a TXOP for communicating the initial frame. In some implementations, the first wireless device 505 may transmit, to the second wireless device 510, a message requesting the second wireless device to initiate frame exchanges with the first wireless device 505 using a control frame that solicits control feedback, where the initial frame may be an ICF communicated to the first wireless device 505.

At 520, the first wireless device 505 may receive the initial frame from the second wireless device 510. In some implementations, the initial frame may be a data frame scheduled by the first wireless device 505 and the second wireless device 510. In some implementations, the initial frame may be an example of an ICF. In some implementations, the initial frame request a response from the first wireless device 505.

At 525, the first wireless device 505 may transmit a first control frame in response to receiving the initial frame (which may be based on the request for the response from the first wireless device 505). In some implementations, the first control frame may be a first BA control frame (such as a CRF). In some implementations, the initial frame may include a request for the first wireless device 505 to initiate frame exchanges with the second wireless device 510 using a control frame that includes control feedback, and the first control frame may be an ICF. In some other implementations, when the initial frame is an ICF, the first control frame may be an ICR frame. The first control frame (e.g., a first control BA frame or other control frame discussed herein) may include first control information (e.g., first BA information), and the first control information may include one or more sets of fields (such as per-AID TID information 345-a and per-AID TID information 345-b described with reference to FIG. 3) associated with one or more wireless devices (such as the second wireless device 510 or one or more second wireless devices including the second wireless device 510). In some implementations, a first set of fields of the one or more sets of fields may include a first information field indicating an identifier associated with one or more second wireless devices including the second wireless device 510 and may include a first feedback field (which may be an example of a first control feedback field) including first control feedback (which may be for the second wireless device 510). In some implementations, the first information field may include a bit sequence (such as a TID subfield value) indicating that the first set of fields includes the first feedback field. In some implementations, the first control information may include feedback information indicating whether the initial frame was successfully received. Such frames containing variable amounts of data or information to support communicating control feedback in addition to other information (such as acknowledgement feedback) may be referred to as flexible control frames.

In some implementations, the first feedback field may indicate a request for the second wireless device 510 to respond with a second control frame indicating whether the first control feedback was successfully received. In some implementations, the second control frame may be a second BA control frame. The request may be based on the first bit sequence and a first bit associated with a subfield (such as an ACK Type subfield) of the information field. The first bit sequence may indicate a first value, and the first set of fields may include the first feedback field based on the first value being one or more reserved values associated with the first information field. In some implementations, the first control feedback may indicate information associated with link adaptation, a BSR, a BQR, P2P communications, power management, coexistence (such as a coexistence mechanism), an OM, a UPH, one or more scheduling parameters (such as a bandwidth, NSS, MCS, a PPDU type or duration, or the like), or any combination thereof, among other examples. As an example, the first control feedback may include one or more operating parameters associated with P2P communications between the second wireless device 510 and a third wireless device (such as another STA).

At 530, the first wireless device 505 may receive a second control frame from the second wireless device 510. In some implementations, the second control frame may be the second BA control frame. The second control frame may include second control information (such as second BA control information) based on the first feedback field indicating the request (soliciting a response). In some implementations, the second control information may include a second set of fields. The second set of fields may include a second Information field indicating the first wireless device 505 and may include a second feedback field including second control feedback, where the second control feedback may indicate whether the first control feedback was successfully received by the second wireless device 510.

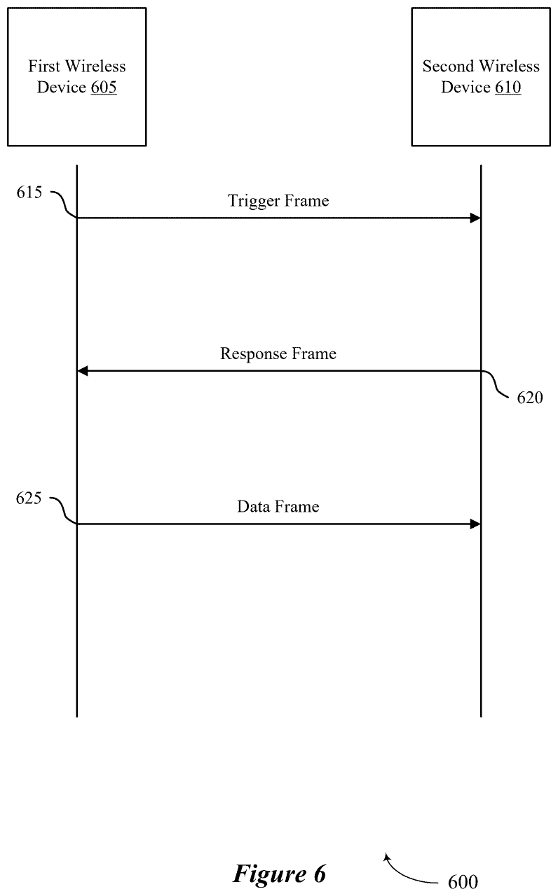

FIG. 6 shows an example process flow that supports communicating flexible control frames between a first wireless device and a second wireless device. The process flow 600 may implement, or be implemented by, one or more aspects of the wireless communications system 100, the signaling diagram 200, and the flexible frame format 400. For example, the process flow 600 illustrates communications between a first wireless device 605 and a second wireless device 610, which may be examples of APs or STAs described with reference to FIGS. 1, 2, and 4. The process flow 600 may support an SU sequence or an MU sequence, and may be performed between any quantity of wireless devices. In the following description of the process flow 600, the operations may be performed (such as reported or provided) in a different order than the order shown, or the operations performed by the example devices may be performed in different orders or at different times. For example, specific operations also may be left out of the process flow 600, or other operations may be added to the process flow 600. Further, although some operations or signaling may be shown to occur at different times for discussion purposes, these operations may actually occur at the same time. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

At 615, the first wireless device 605 may transmit, to the second wireless device 610, a first control frame, which may be an example of an ICF (such as an RTS frame, CTS frame, basic trigger frame, or the like). For example, the first control frame may be an example of a trigger frame. The first control frame may include multiple user information fields and may include one or more feedback fields. In some implementations, a first user information field of the multiple user information fields may include a bit sequence (such as an AID subfield value) that indicates the first control frame includes the one or more feedback fields. The bit sequence may be a reserved value associated with the first user information field. In some implementations, the one or more feedback fields may include first control feedback indicating whether the second wireless device 610 is to respond to the first control feedback with second control feedback. Such frames containing variable amounts of data or information to support communicating control feedback in addition to other information (such as information associated with a TXOP) may be referred to as flexible control frames.

In some implementations, both of the first user information field and a second user information field may be associated with the second wireless device 610. In some implementations, the first user information field may indicate one or more RUs for communicating a data frame and the second user information field may indicate the first control feedback. In some implementations, the first user information field may include a first subfield indicating a length associated with the first user information field. In some implementations, the first user information field may include one or more subfields, and the first user information field and the feedback field may be subfields included within a same field of the first control frame based on a first subfield of the one or more subfields indicating the bit sequence. In some implementations, the first control feedback may indicate information associated with link adaptation, a BSR, a BQR, P2P communications, power management, coexistence (such as a coexistence mechanism), an OM, a UPH, one or more scheduling parameters (such as a bandwidth, NSS, MCS, a PPDU type or duration, or the like), among other examples.

At 620, the first wireless device 605 may receive, from the second wireless device 610, a response frame responsive to the first control frame (such as an ICR frame or CRF). The response frame may be generated in accordance with the first control feedback. For example, the response frame may include the second control feedback based on the first control feedback indicating a request for the second wireless device 610 to respond with the second control feedback indicating whether the first control feedback was successfully received. Alternatively, the response frame may not include the second control feedback if the first control feedback does not solicit a response for the second wireless device 610.

At 625, the first wireless device 605 may transmit, to the second wireless device 610, a data frame based on receiving the response frame. In some implementations, the data frame may be generated in accordance with the first control feedback, the second control feedback, or both (such as when the control feedbacks indicate communication parameters for the data frame).

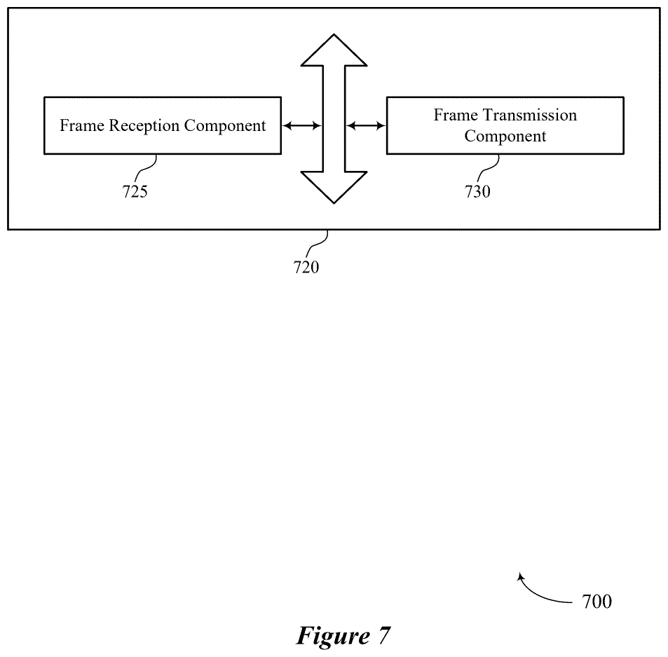

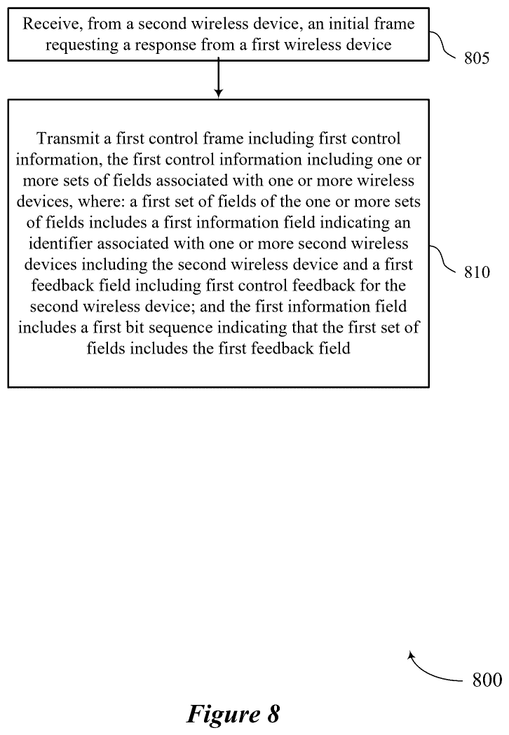

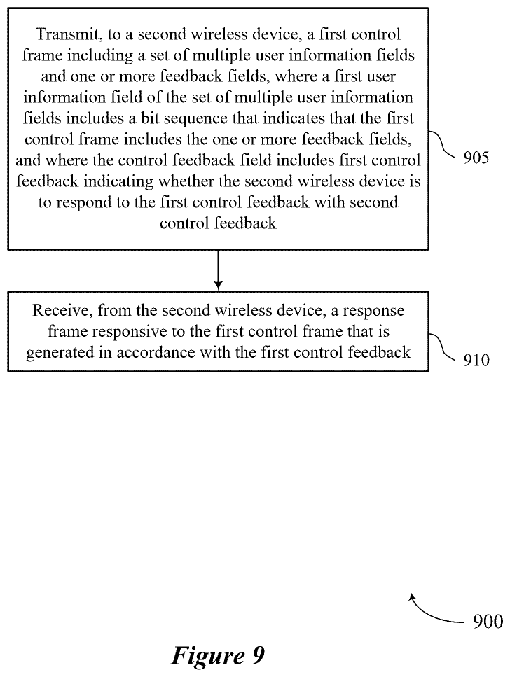

FIG. 7 shows a block diagram of an example wireless communication device 700 that supports flexible control frames. In some examples, the wireless communication device 700 is configured to perform the processes 800 and 900 described with reference to FIGS. 8 and 9, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can configurable or configured for use in an AP or STA, such as the AP 102 or the STA 104 described with reference to FIG. 1. In some other examples, the wireless communication device 700 can be an AP or STA that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes a user interface (UI) (such as a touchscreen or keypad) and a display, which may be integrated with the UI to form a touchscreen display that is coupled with the processing system. In some examples, the wireless communication device 700 may further include one or more sensors such as, for example, one or more inertial sensors, accelerometers, temperature sensors, pressure sensors, or altitude sensors, that are coupled with the processing system. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a frame reception component 725 and a frame transmission component 730. Portions of one or more of the frame reception component 725 and the frame transmission component 730 may be implemented at least in part in hardware or firmware. For example, one or more of the frame reception component 725 and the frame transmission component 730 may be implemented at least in part by at least a processor or a modem. In some examples, portions of one or more of the frame reception component 725 and the frame transmission component 730 may be implemented at least in part by a processor and software in the form of processor-executable code stored in memory.

The wireless communication device 700 may support wireless communication in accordance with examples as disclosed herein. The frame reception component 725 is configurable or configured to receive, from a second wireless device, an initial frame requesting a response from the first wireless device. The frame transmission component 730 is configurable or configured to transmit a first control frame in response to receiving the initial frame, the first control frame including first control information, the first control information including one or more sets of fields associated with one or more wireless devices, where: a first set of fields of the one or more sets of fields includes a first information field indicating the second wireless device and a first feedback field including first control feedback for the second wireless device; and the first information field includes a first bit sequence indicating that the first set of fields includes the first feedback field.

In some examples, the first feedback field may indicate a request for the second wireless device to respond with a second control frame indicating whether the first control feedback was successfully received, and the request is based on the first bit sequence and a first bit associated with a subfield of the first information field.

In some examples, the frame reception component 725 is configurable or configured to receive the second control frame including second control information based on the first feedback field indicating the request, the second control information including a second set of fields, where: the second set of fields includes a second information field indicating the first wireless device and a second feedback field including second control feedback, the second control feedback indicating whether the first control feedback was successfully received; and the second information field includes a second bit sequence indicating that the second set of fields includes the second control feedback.

In some examples, the first control frame may be a flexible control frame.

In some examples, the first control feedback may indicate information associated with link adaptation, a BSR, a BQR, P2P communications, power management, coexistence, an OM, a UPH, one or more scheduling parameters, or any combination thereof.

In some examples, the first bit sequence may indicate a first value. In some examples, the first set of fields may include the first feedback field based on the first value being one or more reserved values associated with the first information field.

In some examples, the first control information may include feedback information indicating whether the initial frame was successfully received.

In some examples, the first control frame may include a BA control frame.

In some examples, the frame transmission component 730 is configurable or configured to transmit, to a second wireless device, a first control frame including a set of multiple user information fields and a feedback field, where a first user information field of the set of multiple user information fields includes a bit sequence that indicates that the first control frame includes the feedback field, and where the feedback field includes first control feedback indicating whether the second wireless device is to respond to the first control feedback with second control feedback. In some examples, the frame reception component 725 is configurable or configured to receive, from the second wireless device, a response frame responsive to the first control frame that is generated in accordance with the first control feedback.

In some examples, the first control feedback may indicate a request for the second wireless device to respond with the second control feedback indicating whether the control feedback was successfully received. In some examples, the response frame include the second control feedback based on the request.

In some examples, both of the first user information field and a second user information field may be associated with the second wireless device. In some examples, the first user information field may indicate one or more resources units for communicating a data frame and the second user information field may indicate the first control feedback.

In some examples, the frame transmission component 730 is configurable or configured to transmit a data frame based on receiving the response frame, where the data frame is generated in accordance with the first control feedback, the second control feedback, or both.

In some examples, the first user information field may include a first subfield that indicates a length associated with the first user information field.

In some examples, the first user information field may include one or more subfields. In some examples, the first user information field and the feedback field may be subfields included within a same field of the first control frame based on a first subfield of the one or more subfields indicating the bit sequence.

In some examples, a value indicated by the bit sequence is a reserved value associated with the first user information field.

In some examples, the first control feedback may indicate information associated with link adaptation, a BSR, a BQR, P2P communications, power management, coexistence, an OM, a UPH, one or more scheduling parameters, or any combination thereof.

In some examples, the first control frame may include a request-to-send frame or a basic trigger frame.

FIG. 8 shows a flowchart illustrating an example process 800 performable by or at a first wireless device that supports flexible control frames. The operations of the process 800 may be implemented by a first wireless device or its components as described herein. For example, the process 800 may be performed by a wireless communication device, such as the wireless communication device 700 described with reference to FIG. 7, operating as or within a wireless AP or a wireless STA. In some examples, the process 800 may be performed by a wireless AP or a wireless STA, such as one of the APs 102 or the STAs 104 described with reference to FIG. 1.

In some examples, in block 805, the first wireless device may receive, from a second wireless device, an initial frame requesting a response from the first wireless device. The operations of block 805 may be performed in accordance with examples as disclosed herein. In some implementations, aspects of the operations of block 805 may be performed by a frame reception component 725 as described with reference to FIG. 7.

In some examples, in block 810, the first wireless device may transmit a first control frame including first control information, the first control information including one or more sets of fields associated with one or more wireless devices, where: a first set of fields of the one or more sets of fields includes a first information field indicating the second wireless device and a first feedback field including first control feedback for the second wireless device; and the first information field includes a first bit sequence indicating that the first set of fields includes the first feedback field. The operations of block 810 may be performed in accordance with examples as disclosed herein. In some implementations, aspects of the operations of block 810 may be performed by a frame transmission component 730 as described with reference to FIG. 7.

FIG. 9 shows a flowchart illustrating an example process 900 performable by or at a first wireless device that supports flexible control frames. The operations of the process 900 may be implemented by a first wireless device or its components as described herein. For example, the process 900 may be performed by a wireless communication device, such as the wireless communication device 700 described with reference to FIG. 7, operating as or within a wireless AP or a wireless STA. In some examples, the process 900 may be performed by a wireless AP or a wireless STA, such as one of the APs 102 or the STAs 104 described with reference to FIG. 1.

In some examples, in block 905, the first wireless device may transmit, to a second wireless device, a first control frame including a set of multiple user information fields and a feedback field, where a first user information field of the set of multiple user information fields includes a bit sequence that indicates that the first control frame includes the feedback field, and where the feedback field includes first control feedback indicating whether the second wireless device is to respond to the first control feedback with second control feedback. The operations of block 905 may be performed in accordance with examples as disclosed herein. In some implementations, aspects of the operations of block 905 may be performed by a frame transmission component 730 as described with reference to FIG. 7.

In some examples, in block 910, the first wireless device may receive, from the second wireless device, a response frame responsive to the first control frame that is generated in accordance with the first control feedback. The operations of block 910 may be performed in accordance with examples as disclosed herein. In some implementations, aspects of the operations of block 910 may be performed by a frame reception component 725 as described with reference to FIG. 7.

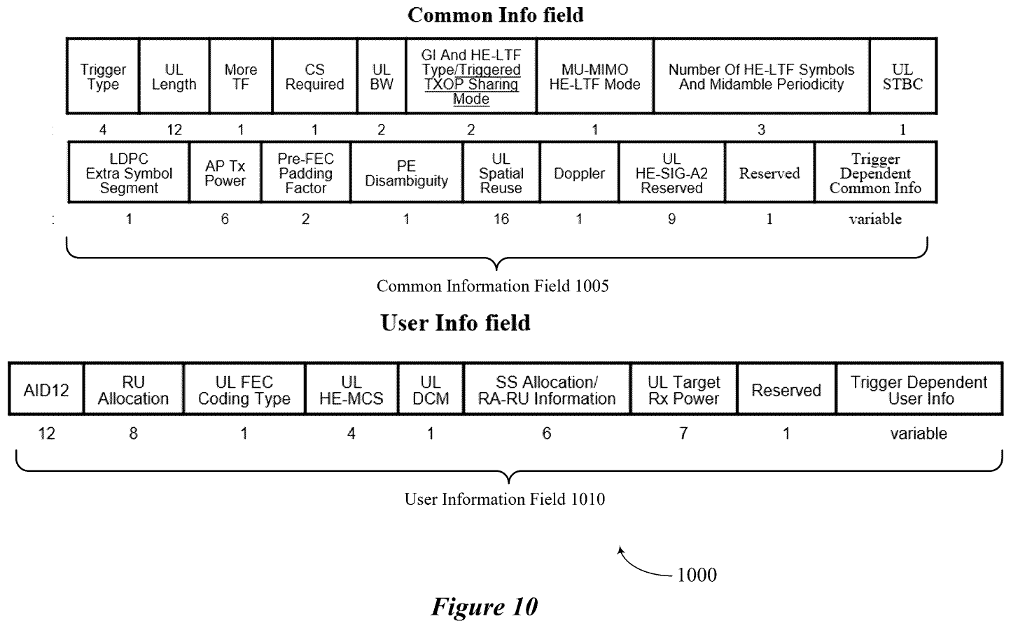

FIG. 10 shows an example of information 1000 included in a trigger frame that supports communications between a first wireless device, such as a wireless AP, and one or more second wireless devices, such as one or more wireless STAs. For example, the information 1000 may be included in a first control frame, such as an ICF, such as an RTS or a CTS frame described herein, among other examples. Additionally, the trigger frame may include a feedback field to indicate additional control information or control feedback as described with reference to FIG. 4. The information 1000 may show information fields included within a common information field 1005 and a user information field 1010, which may be examples of a common information field 460 and a user information field 450, respectively, described with reference to FIG. 4. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

The common information field 1005 may include one or more information fields (such as subfields) indicating information common to one or more receiving STAs. The one or more information fields may include a trigger type field, an uplink length field, a more TF frame, a CS required field, an uplink bandwidth field, a guard interval (GI) and HE-LTF type field including a triggered TXOP sharing mode indication, an MU-MIMO HE-LTF mode field, a number of HE-LTF symbols and midamble periodicity field, an uplink space-time block code (STBC) field, a LDPC extra symbol segment field, an AP transmit power field, a pre-forward error correction (FEC) padding factor field, a packet extension (PE) disambiguity field, an uplink spatial reuse field, a doppler field, an uplink HE-SIG-A2 reserved field, a reserved field, a trigger dependent common information field, or any combination thereof.

The user information field 1010 may include one or more information fields (such as subfields) indicating information for a receiving STA. The one or more information fields may include an AID12 field, an RU allocation field, an uplink FEC coding type field, an uplink HE-MCS field, an uplink dual carrier modulation (DCM) field, a service set (SS) allocation/RA-RU information field, an uplink target reception power field, a reserved field, a trigger dependent user information field, or any combination thereof.

In some implementations, a value of the triggered TXOP sharing mode may indicate information about the trigger frame received by a STA. Such information may indicate a TSOP sharing procedure for a receiving STA (such as when the trigger frame is associated with other STAs). For example, table 2 below shows various interpretations of a trigger frame by a receiving STA.

TABLE 2

| Triggered TXOP Sharing | |
|---|---|
| Mode Subfield Value | Description |
| 0 | MU-RTS that does not initiate triggered |
| | TXOP sharing procedure. |
| 1 | MU-RTS that initiates triggered TXOP |
| | sharing procedure wherein a scheduled |
| | STA can only transmit MPDU(s) |
| | addressed to its associated AP. |
| 2 | MU-RTS that initiates triggered TXOP |
| | sharing procedure wherein a scheduled |
| | STA can transmit MPDU(s) addressed to |
| | its associated AP or addressed to another |
| | STA. |
| 3 | Reserved |

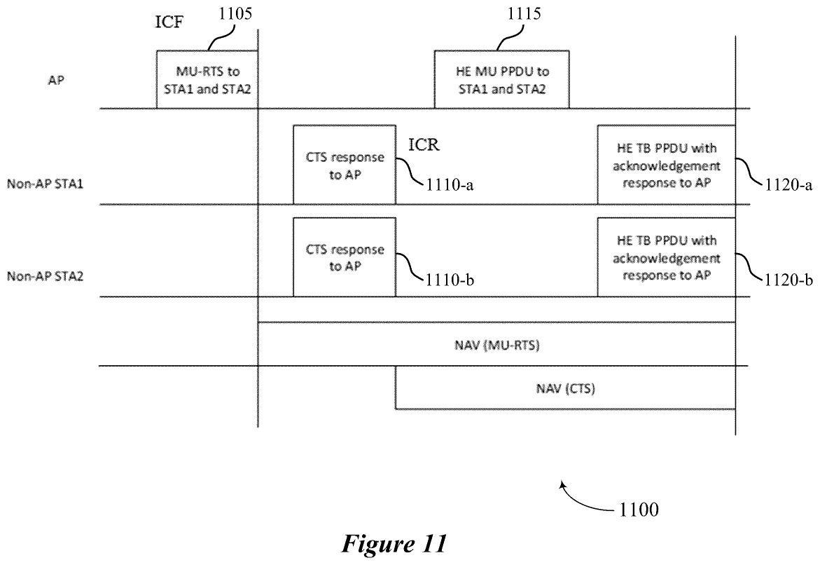

According to the triggered TXOP sharing mode value, the receiving STA may determine whether to respond with one or more MPDUs addressed to an associated AP, another STA, or a combination thereof, as described further with reference to FIGS. 11-13.

FIG. 11 shows an example of a communication sequence 1100 supporting a trigger frame variant usable for communications between a first wireless device, such as a wireless AP, and one or more second wireless devices, such as one or more wireless STAs. In some implementations, the communication sequence 1100 may include the AP transmitting an ICF 1105 to one or more receiving STAs, such as a non-AP STA1 and a non-AP STA2. For example, the AP may transmit the ICF 1105 as an MU-RTS to the non-AP STA1 and the non-AP STA2 to trigger a TXOP. In some implementations, the ICF 1105 may include a feedback field to indicate additional control information or control feedback as described herein. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

The ICF 1105 may be individually addressed to a receiving STA. For example, the ICF 1105 may include a MAC address associated with the non-AP STA1 or the non-AP STA2 in an RA field. In some implementations, the ICF 1105 may protect one or more downlink transmissions to the one or more receiving STAs. The ICF 1110 may include a triggered TXOP sharing mode value in a common information field as described with reference to table 2 of FIG. 10. For example, the triggered TXOP sharing mode may include a value of 0, which may indicate that ICF 1110 does not initiate a triggered TXOP sharing procedure.

The receiving STAs may respond to the ICF 1105 with respective ICR frames 1110. For example, the non-AP STA1 may transmit, in response to the ICF 1105, an ICR frame 1110-a, which may be an example of a CTS frame described herein. Similarly, the non-AP STA2 may transmit, in response to the ICF 1105, an ICR frame 1110-b, which may be an example of a CTS frame described herein. In some implementations, the ICR frames 1110 may include a feedback field indicating additional control information or control feedback information as described herein.

The wireless devices may continue to communicate in an MU sequence according to techniques described with reference to FIG. 2. For example, the AP may transmit an HE MU PPDU 1115 to the non-AP STA1 and the non-AP STA2 including data for the receiving STAs. Further, the non-AP STA1 and the non-AP STA2 may transmit, in response to the HE MU PPDU 1115, an HE TB PPDU 1120-a and an HE TB PPDU 1120-b (which may be examples of CRFs described herein), respectively, with acknowledgement feedback (which may indicate a reception status of the received data). These frames (such as the HE MU PPDU 1115 and HE TB PPDUs 1120) may further include a feedback field indicating additional control information or control feedback information as described herein.

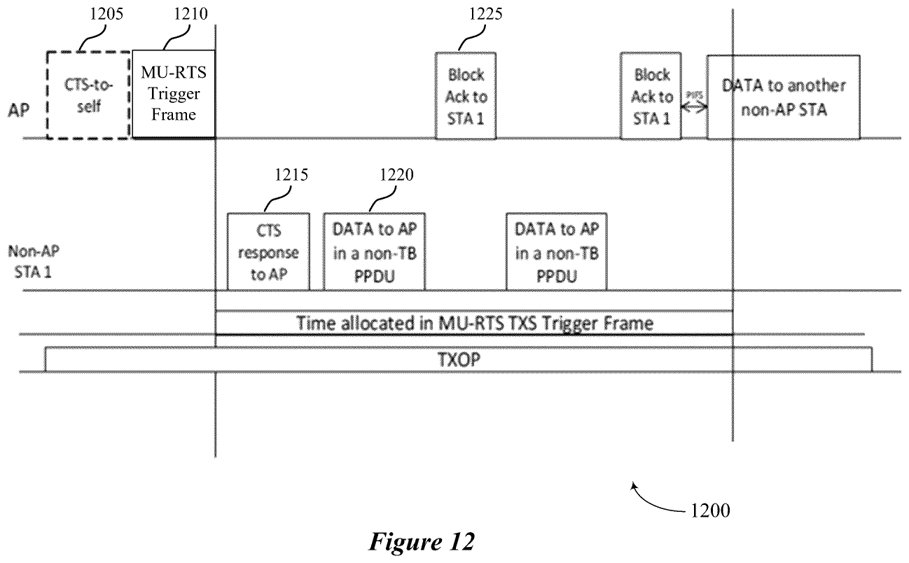

FIG. 12 shows an example of a communication sequence 1200 supporting a trigger frame variant usable for communications between a first wireless device, such as a wireless AP, and one or more second wireless devices, such as one or more wireless STAs. For example, the AP may communicate with a non-AP STA1 using an SU communication sequence described with reference to FIG. 2. In some implementations, the AP may transmit a CTS-to-self frame 1205 (which may be a mechanism to protect a TXOP) to support communicating an ICF 1210 to trigger a TXOP. For example, after transmitting the CTS-to-self frame 1205, the AP may transmit the ICF 1210. In some implementations, the AP may transmit the ICF 1210 as an MU-RTS trigger frame to the non-AP STA1 to trigger the TXOP. The ICF 1210 may be individually addressed to the non-AP STA1 (such as by including an individual MAC address of the non-AP STA1 in an RA field) to protect one or more uplink transmissions from the non-AP STA1. In some implementations, the ICF 1105 may include a feedback field to indicate additional control information or control feedback as described herein. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

The ICF 1210 may include a triggered TXOP sharing mode value in a common information field as described with reference to table 2 of FIG. 10. For example, the triggered TXOP sharing mode may include a value of 1, which may indicate that the non-AP STA1 is to transmit one or more MPDUs to the AP within a duration specified by the ICF 1210. In some implementations, the non-AP STA1 may respond to the ICF 1210 with an ICR frame 1215, (such as a CTS frame), and may include a feedback field to indicate additional control information or control feedback as described herein.

In some implementations, the non-AP STA1 may transmit data to the AP after exchanging the ICF 1210 and the ICR frame 1215 with the AP (such as during the time allocated in the MU-RTS trigger frame). For example, the non-AP STA1 may transmit the data as one or more MPDUs included in a non-TB PPDU 1220. In some implementations, the AP may respond to the data received from the non-AP STA1 with a CRF 1225. For example, the CRF 1225 may be an example of a BA frame including acknowledgement feedback for the received data. In some implementations, the CRF 1225 may include a feedback field to indicate additional control information or control feedback as described herein. Further, the AP and the non-AP STA1 may perform one or more additional data and CRF exchanges during the time allocated within the TXOP.

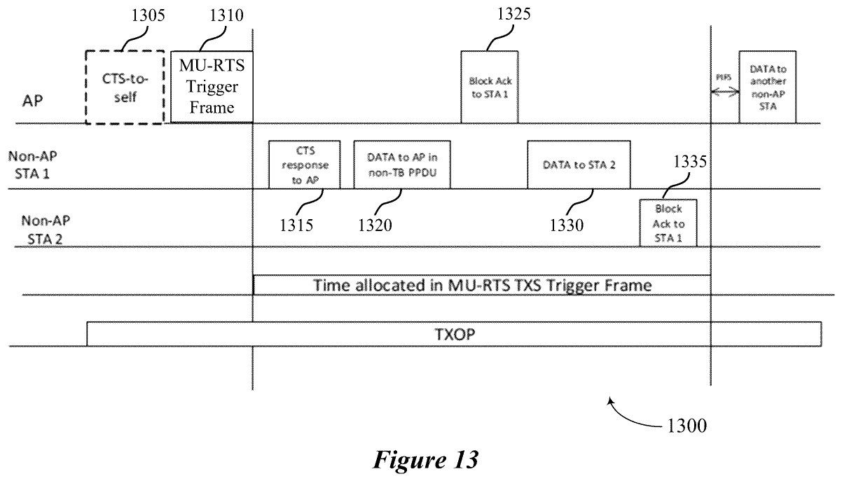

FIG. 13 shows an example of a communication sequence 1300 supporting a trigger frame variant usable for communications between a first wireless device, such as a wireless AP, and one or more second wireless devices, such as one or more wireless STAs. For example, the AP may communicate with a non-AP STA1 and the non-AP STA1 may communicate with a non-AP STA2. In some implementations, the AP may transmit a CTS-to-self frame 1305 to support communicating an ICF 1310 to trigger a TXOP. For example, after transmitting the CTS-to-self frame 1305, the AP may transmit the ICF 1310. In some implementations, the AP may transmit the ICF 1310 as an MU-RTS trigger frame to the non-AP STA1 to trigger the TXOP. The ICF 1310 may be individually addressed to the non-AP STA1 or the non-AP STA2 (such as by including an individual MAC address of the non-AP STA1 in an RA field) to protect one or more uplink transmissions from the non-AP STA1 and the non-AP STA2. In some implementations, the ICF 1105 may include a feedback field to indicate additional control information or control feedback as described herein. It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

The ICF 1310 may include a triggered TXOP sharing mode value in a common information field as described with reference to table 2 of FIG. 10. In a first example, the triggered TXOP sharing mode may include a value of 2, which may indicate that the non-AP STA1, the non-AP STA2, or both are to transmit one or more MPDUs addressed to the AP or addressed to another STA within a duration specified by the ICF 1310. In some implementations, the non-AP STA1 may respond to the ICF 1310 with an ICR frame 1315 (such as a CTS frame), and may include a feedback field to indicate additional control information or control feedback as described herein.

In a second example, the triggered TXOP sharing mode may include a value of 3, which may define an enhanced CTS frame (such as an MU RTS CTS trigger frame) for the non-AP STA1, the non-AP STA2, or both. For example, the non-AP STA1 may transmit the ICR frame 1315 using the enhanced CTS frame. Such an enhanced CTS frame may be transmitted as a response to a trigger frame (such as an MU RTS trigger, the variants of the MU RTS trigger described herein, or any other trigger frame). For example, the enhanced CTS frame may act as an ICR frame and may include a feedback field to indicate additional control information or control feedback as described herein.

In some implementations, the non-AP STA1 may transmit data to the AP after exchanging the ICF 1310 and the ICR frame 1315 with the AP. For example, the non-AP STA1 may transmit the data as one or more MPDUs included in a non-TB PPDU 1320. In some implementations, the AP may respond to the data received from the non-AP STA1 with a CRF 1325. For example, the CRF 1325 may be an example of a BA frame including acknowledgement feedback for the received data. In some implementations, based on the TXOP sharing mode value indicated by the ICF 1310, the non-AP STA1 may transmit data 1330 to the non-AP STA2. In response to receiving the data 1330, the non-AP STA2 may transmit a CRF 1335 to the non-AP STA2. For example, the CRF 1335 may be an example of a BA frame including acknowledgement feedback for the received data 1330. In some implementations, the CRF 1325, the CRF 1335, or both may include a feedback field to indicate additional control information or control feedback as described herein.

FIG. 14 shows an example of a trigger frame variant 1400 usable for communications between a first wireless device, such as a wireless AP, and one or more second wireless devices, such as one or more wireless STAs. In some cases, the trigger frame variant 1400 may include one or more information fields (such as subfields), which may be examples of information fields in a trigger frame 405 described with reference to FIG. 4. For example, the trigger frame variant 1400 may include a frame control field, a duration field, an RA field, a TA field, a common information field, a user information list, a padding field, and an FCS field. Additionally, the trigger frame variant 1400 may include a feedback field to indicate additional control information or control feedback as described herein. In some implementations, the feedback field may be a separate field, which may be included after the user information list (instead of within the user information list as described with reference to FIG. 4). Alternatively, the feedback field may be included within the common information field (such as within one or more reserved fields of the common information field). It should be noted that while the illustrated example refers to an AP communicating with one or more STAs, the sequence may support other device configurations, such as a STA indicating control feedback to one or more APs, a STA indicating control feedback to one or more other STAs, a first wireless device communicating with a second wireless device, or any combination of devices with different functionalities.

Implementation examples are described in the following numbered clauses:

Clause 1: A method for wireless communication by a first wireless device, comprising: receiving, from a second wireless device, an initial frame requesting a response from the first wireless device; and transmitting a first control frame comprising first control information, the first control information comprising one or more sets of fields associated with one or more wireless devices, wherein: a first set of fields of the one or more sets of fields comprises a first information field indicating an identifier associated with one or more second wireless devices comprising the second wireless device and a first feedback field comprising first feedback; and the first information field comprises a first bit sequence indicating that the first set of fields comprises the first feedback field.

Clause 2: The method of clause 1, wherein the identifier indicates a plurality of the one or more second wireless devices.

Clause 3: The method of any of clauses 1 and 2, wherein the first control frame comprises a trigger frame.

Clause 4: The method of any of clauses 1 through 3, wherein the first control feedback indicates one or more operating parameters associated with P2P communications between the second wireless device and a third wireless device.

Clause 5: The method of any of clauses 1 through 4, wherein the first control feedback comprises a control feedback unit that indicates an identifier associated with the first control feedback, an identifier of a link associated with the first control feedback, a length associated with the first control feedback, or any combination thereof.

Clause 6: The method of any of clauses 1 through 5, wherein the first control frame comprises one or more feedback fields comprising at least the first control feedback, and wherein each of the one or more feedback fields comprises respective control feedback for the one or more second wireless devices.

Clause 7: The method of any of clauses 1 through 6, wherein the first control frame comprises one or more padding bits that follow the first set of fields, and wherein the one or more padding bits follow a frame check sequence included in the first control frame.

Clause 8: The method of any of clauses 1 through 7, further comprising: transmitting, to the second wireless device, a message requesting the second wireless device to initiate frame exchange with the first wireless device using a control frame that solicits the first control feedback, wherein the initial frame comprises an initial control frame and the first control frame comprises a initial control response based at least in part on transmission of the message.

Clause 9: The method of any of clauses 1 through 8, wherein the initial frame comprises a request for the first wireless device to initiate frame exchanges with the second wireless device using a control frame that includes the first control feedback, and wherein the first control frame comprises an initial control frame based at least in part on reception of the initial frame comprising the request.

Clause 10: The method of any of clauses 1 through 9, wherein the first feedback field indicates a request for the second wireless device to respond with a second control frame indicating whether the first control feedback was successfully received, and the request is based at least in part on the first bit sequence and a first bit associated with a subfield of the first information field.

Clause 11: The method of clause 10, further comprising: receiving the second control frame comprising second control information based at least in part on the first feedback field indicating the request, the second control information comprising a second set of fields, wherein: the second set of fields comprises a second information field indicating the first wireless device and a second feedback field comprising second control feedback, the second control feedback indicating whether the first control feedback was successfully received; and the second information field comprises a second bit sequence indicating that the second set of fields comprises the second control feedback.

Clause 12: The method of clause 10, wherein the second control frame comprises a block acknowledgement control frame.

Clause 13: The method of any of clauses 1 through 11, wherein the first control frame is a flexible control frame.

Clause 14: The method of any of clauses 1 through 13, wherein the first control feedback indicates information associated with link adaptation, a BSR, a BQR, P2P communications, power management, coexistence, unavailability periods, a periodicity of the unavailability periods, an OM, a UPH, one or more scheduling parameters, one or more interference patterns, a solicited PPDU type, a solicited PPDU duration, an NSS, or any combination thereof.

Clause 15: The method of any of clauses 1 through 14, wherein the first bit sequence indicates a first value, and the first set of fields comprises the first feedback field based at least in part on the first value being one or more reserved values associated with the first information field.

Clause 16: The method of any of clauses 1 through 15, wherein the first control information comprises feedback information indicating whether the initial frame was successfully received.

Clause 17: The method of any of clauses 1 through 16, wherein the first control frame comprises a BA control frame.

Clause 18: A method at a first wireless device, comprising: transmitting, to a second wireless device, a first control frame comprising a plurality of user information fields and a one or more feedback fields, wherein a first user information field of the plurality of user information fields comprises a bit sequence that indicates that the first control frame comprises the one or more feedback fields, and wherein the one or more feedback fields comprise first control feedback indicating whether the second wireless device is to respond to the first control feedback with second control feedback; and receiving, from the second wireless device, a response frame responsive to the first control frame that is generated in accordance with the first control feedback.

Clause 19: The method of clause 18, wherein the first control frame, the response frame, or both comprise one or more padding bits that follow a frame check sequence included in the first control frame, the response frame, or both.

Clause 20: The method of any of clauses 18 and 19, wherein the first control feedback indicates a request for the second wireless device to respond with the second control feedback indicating whether the control feedback was successfully received, the response frame comprises the second control feedback based at least in part on the request.

Clause 21: The method of any of clauses 18 through 20, wherein both of the first user information field and a second user information field are associated with the second wireless device, and the first user information field indicates one or more resources units for communicating a data frame and the second user information field indicates the first control feedback.

Clause 22: The method of any of clauses 18 through 21, further comprising: transmitting a data frame based at least in part on receiving the response frame, wherein the data frame is generated in accordance with the first control feedback, the second control feedback, or both.

Clause 23: The method of any of clauses 18 through 22, wherein the first user information field comprises a first subfield that indicates a length associated with the first user information field.

Clause 24: The method of any of clauses 18 through 23, wherein the first user information field comprises one or more subfields, and the first user information field and the one or more feedback fields are subfields included within a same field of the first control frame based at least in part on a first subfield of the one or more subfields indicating the bit sequence.

Clause 25: The method of any of clauses 18 through 24, wherein a value indicated by the bit sequence is a reserved value associated with the first user information field.

Clause 26: The method of any of clauses 18 through 25, wherein the first control feedback indicates information associated with link adaptation, a BSR, a BQR, P2P communications, power management, coexistence, unavailability periods, a periodicity of the unavailability periods, an OM, a UPH, one or more scheduling parameters, one or more interference patterns, a solicited PPDU type, a solicited PPDU duration, an NSS, or any combination thereof.

Clause 27: The method of any of clauses 18 through 26, wherein the first control frame comprises an RTS frame or a basic trigger frame.

Clause 28: A first wireless device for wireless communication, comprising one or more memories storing processor-executable code, and one or more processors coupled with the one or more memories and individually or collectively operable to execute the code to cause the first wireless device to perform a method of any of clauses 1 through 17.

Clause 29: A first wireless device for wireless communication, comprising at least one means for performing a method of any of clauses 1 through 17.

Clause 30: A non-transitory computer-readable medium storing code for wireless communication, the code comprising instructions executable by a processor to perform a method of any of clauses 1 through 17.

Clause 31: A first wireless device comprising one or more memories storing processor-executable code, and one or more processors coupled with the one or more memories and individually or collectively operable to execute the code to cause the first wireless device to perform a method of any of clauses 18 through 27.

Clause 32: A first wireless device comprising at least one means for performing a method of any of clauses 18 through 27.

Clause 33: A non-transitory computer-readable medium storing code the code comprising instructions executable by a processor to perform a method of any of clauses 18 through 27.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a first wireless device, comprising:
one or more memories storing processor-executable code; and
one or more processors coupled with the one or more memories and individually or collectively operable to execute the code to cause the first wireless device to:
receive, from a second wireless device, an initial frame requesting a response from the first wireless device; and
transmit a first control frame comprising first control information, the first control information comprising one or more sets of fields associated with one or more wireless devices, wherein:
a first set of fields of the one or more sets of fields comprises a first information field indicating an identifier associated with one or more second wireless devices comprising the second wireless device and a first feedback field comprising first control feedback; and
the first information field comprises a first bit sequence indicating that the first set of fields comprises the first feedback field.

2. The apparatus of claim 1, wherein the identifier indicates a plurality of the one or more second wireless devices.

3. The apparatus of claim 1, wherein the first control frame comprises a trigger frame.

4. The apparatus of claim 1, wherein the first control feedback indicates one or more operating parameters associated with peer-to-peer communications between the second wireless device and a third wireless device.

5. The apparatus of claim 1, wherein the first control feedback comprises a control feedback unit that indicates an identifier associated with the first control feedback, an identifier of a link associated with the first control feedback, a length associated with the first control feedback, or any combination thereof.

6. The apparatus of claim 1, wherein the first control frame comprises one or more feedback fields comprising at least the first control feedback, and wherein each of the one or more feedback fields comprises respective control feedback for the one or more second wireless devices.

7. The apparatus of claim 1, wherein the first control frame comprises one or more padding bits that follow the first set of fields, and wherein the one or more padding bits follow a frame check sequence included in the first control frame.

8. The apparatus of claim 1, wherein the one or more processors are individually or collectively further operable to execute the code to cause the first wireless device to:
transmit, to the second wireless device, a message requesting the second wireless device to initiate frame exchange with the first wireless device using a control frame that solicits the first control feedback, wherein the initial frame comprises an initial control frame and the first control frame comprises an initial control response based at least in part on transmission of the message.

9. The apparatus of claim 1, wherein:
the initial frame comprises a request for the first wireless device to initiate frame exchanges with the second wireless device using a control frame that includes the first control feedback; and
the first control frame comprises an initial control frame based at least in part on reception of the initial frame comprising the request.

10. The apparatus of claim 1, wherein the first feedback field indicates a request for the second wireless device to respond with a second control frame indicating whether the first control feedback was successfully received, and the request is based at least in part on the first bit sequence and a first bit associated with a subfield of the first information field.

11. The apparatus of claim 10, wherein the one or more processors are individually or collectively further operable to execute the code to cause the first wireless device to:
receive the second control frame comprising second control information based at least in part on the first feedback field indicating the request, the second control information comprising a second set of fields, wherein:
the second set of fields comprises a second information field indicating the first wireless device and a second feedback field comprising second control feedback, the second control feedback indicating whether the first control feedback was successfully received; and
the second information field comprises a second bit sequence indicating that the second set of fields comprises the second control feedback.

12. The apparatus of claim 10, wherein the second control frame comprises a block acknowledgement control frame.

13. The apparatus of claim 1, wherein the first control frame is a flexible control frame.

14. The apparatus of claim 1, wherein the first control feedback indicates information associated with link adaptation, a buffer status report, a bandwidth query report, peer-to-peer communications, power management, coexistence, unavailability periods, a periodicity of the unavailability periods, an operating mode, an uplink power headroom, one or more scheduling parameters, one or more interference patterns, a solicited physical protocol data unit type, a solicited physical protocol data unit duration, a number of spatial streams, or any combination thereof.

15. The apparatus of claim 1, wherein the first bit sequence indicates a first value, and the first set of fields comprises the first feedback field based at least in part on the first value being one or more reserved values associated with the first information field.

16. The apparatus of claim 1, wherein the first control information comprises feedback information indicating whether the initial frame was successfully received.

17. The apparatus of claim 1, wherein the first control frame comprises a block acknowledgment control frame.

18. An apparatus of wireless communication at a first wireless device, comprising:
one or more memories storing processor-executable code; and
one or more processors coupled with the one or more memories and individually or collectively operable to execute the code to cause the first wireless device to:
transmit, to a second wireless device, a first control frame comprising a plurality of user information fields and a one or more feedback fields, wherein a first user information field of the plurality of user information fields comprises a bit sequence that indicates that the first control frame comprises the one or more feedback fields, and wherein the one or more feedback fields comprise first control feedback indicating whether the second wireless device is to respond to the first control feedback with second control feedback; and
receive, from the second wireless device, a response frame responsive to the first control frame that is generated in accordance with the first control feedback.

19. The apparatus of claim 18, wherein the first control frame, the response frame, or both comprise one or more padding bits that follow a frame check sequence included in the first control frame, the response frame, or both.

20. A method for wireless communication at a first wireless device, comprising:
receiving, from a second wireless device, an initial frame requesting a response from the first wireless device; and
transmitting a first control frame comprising first control information, the first control information comprising one or more sets of fields associated with one or more wireless devices, wherein:
a first set of fields of the one or more sets of fields comprises a first information field indicating an identifier associated with one or more second wireless devices comprising the second wireless device and a first feedback field comprising first control feedback; and
the first information field comprises a first bit sequence indicating that the first set of fields comprises the first feedback field.
